(19) United States
(12) Patent Application Publication
(10) Pub. No.: US 2016/0055293 A1
(43) Pub. Date: Feb. 25, 2016

(54) Systems, Algorithms, and Software for Molecular Inversion Probe (MIP) Design

(71) Applicant: UNIVERSITY OF WASHINGTON THROUGH ITS CENTER FOR COMMERCIALIZATION, Seattle, WA (US)

(72) Inventors: Jay Shendure, Seattle, WA (US); Evan Boyle, Seattle, WA (US)

(21) Appl. No.: 14/780,567

(22) PCT Filed: Mar. 26, 2014
(86) PCT No.: PCT/US14/31789

§ 371 Date: Sep. 28, 2015

Related U.S. Application Data
(60) Provisional application No. 61/806,652, filed on Mar. 29, 2013.

(51) Int. Cl. G06F 19/16; C40B 30/02

(52) U.S. Cl. CPC G06F 19/16; C40B 30/02

(57) ABSTRACT

Methods and apparatus are provided for designing molecular inversion probes (MIPs). A computing device can determine representations of sequence features of a reference genome. The computing device can assess target arms that meet design criteria for a MIP in matching the representations of sequence features. For each pair of target arms that meet the design criteria, the computing device can: determine MIP performance data features for the pair, and determine a score for the pair using a MIP performance model operating on the MIP performance data features for the pair. The computing device can determine a subset of the target arms that collectively tile all of the sequence features, where the subset is determined based on the target arm scores. The computing device can determine designed MIPs based on the subset of target arms. The computing device can output information about each designed MIP.

### CROSS-REFERENCE TO RELATED APPLICATIONS

The present application claims priority to U.S. Provisional Patent Application No. 61/806,652, entitled “Algorithms and Software For Molecular Inversion Probe (MIP) Design”, filed Mar. 29, 2013, which is entirely incorporated by reference herein for all purposes.

### STATEMENT OF GOVERNMENT RIGHTS

This invention was made with government support under Grant No. 5R21CA160080-02, awarded by the National Institutes of Health (NIH). The U.S. government has certain rights in the invention.

### BACKGROUND

Identification of a genotype, or genetic makeup of an organism, is being used to diagnose and predict diseases for various organisms, including humans. For example, a physician can use information about the genotype of a person to help make decisions about genetically-oriented diseases, prognosis, and therapeutic options for the person. In particular, rare variants and de novo mutations contribute to the genetic basis of complex diseases including intellectual disability, autism spectrum disorders, epilepsy, and congenital heart disease. The implication of individual genes in these diseases can lead to sequencing of large numbers of cases and controls. While the cost of exome and whole genome sequencing continues to decline, the sizes of cohorts to be sequenced renders these strategies cost-prohibitive for most groups, motivating targeted sequencing of specific candidate genes.

Molecular inversion probes (MIPs) have been proven successful in a broad range of applications, including targeted genotyping, DNA sequencing assessing copy number and content, methylation patterns, RNA allelotyping, and detection of bacteria in clinical samples. In many scenarios, MIPs have a low amortized cost per sample and are highly scalable.

A MIP can be a linear unbranched nucleic acid that includes two target arms, two polymerase chain reaction (PCR) primer sites, and perhaps a probe-release site. A target arm is an oligonucleotide complementary to part of a genetic sequence of interest. Each target arm is at an end of the MIP; e.g., a target arm at the 3′ end of the MIP can be termed an “extension arm” and a target arm at the 5′ end of the MIP can be termed a “ligation” arm. A PCR primer site can be a strand of nucleic acid that can be used to start DNA reactions; e.g., PCRs.

In some cases, the PCR primer site can include one or more restriction sites, or specific nucleotide sequences recognized by restriction enzymes. Restriction enzymes can cleave a string of nucleic acid at or near a restriction site. The probe-release site can be a restriction site to permit cleaving of the MIP. Some MIPs can include a “tag” or “barcode” sequence of nucleotides to uniquely identify a MIP.

When nucleotides of both target arms of a MIP “read” or match nucleotides of the genetic sequence of interest, the MIP can circularize, or bend from a linear shape into a circular or oval shape. The two target arms can match the genetic sequence of interest with a gap of one or more nucleotides between the target arms. Each circularized MIP matches at least part of the genetic sequence of interest. If one MIP does not match the entire genetic sequence of interest, multiple MIPs can be used to “tile” or cover the genetic sequence of interest. Then, by determining which MIPs read the genetic sequence of interest and where the MIPs start reading the genetic sequence of interest, the genetic sequence of interest can be determined.

### SUMMARY

In one aspect, a method is provided. A computing device determines one or more representations of sequence features of a reference genome. The computing device assesses a set of possible target arms that meet one or more design criteria for a MIP in matching the one or more representations of sequence features. For each possible pair of target arms in the set of possible target arms that meet the one or more design criteria, the computing device: determines MIP performance data features for the pair of possible target arms, and determines a score for the pair of possible target arms using a MIP performance model operating on the MIP performance data features for the pair of possible target arms. The computing device determines a subset of the set of possible target arms that tile each of the one or more representations of sequence features using the computing device, where the subset is determined based on the scores for the set of possible target arms. The computing device determines a set of designed MIPs based on the subset of the set of possible target arms that collectively tile all of the one or more representations of sequence features. The computing device provides an output that includes information about each designed MIP of the set of designed MIPs.

In another aspect, a computing device is provided. The computing device includes a processor and a non-transitory tangible computer readable medium. The non-transitory tangible computer readable medium is configured to store at least executable instructions. The executable instructions, when executed by the processor, cause the computing device to perform functions including: determining one or more representations of sequence features of a reference genome; assessing a set of possible target arms that meet one or more design criteria for a MIP in matching the one or more representations of sequence features; for each possible pair of target arms in the set of possible target arms that meet the one or more design criteria: determining MIP performance data features for the pair of possible target arms, and determining a score for the pair of possible target arms using a MIP performance model operating on the MIP performance data features for the pair of possible target arms; determining a subset of the set of possible target arms that tile each of the one or more representations of sequence features, where the subset is determined based on the scores for the set of possible target arms; determining a set of designed MIPs based on the subset of the set of possible target arms that collectively tile all of the one or more representations of sequence features; and providing an output including information about each designed MIP of the set of designed MIPs.

In another aspect, an article of manufacture is provided. The article of manufacture includes a non-transitory tangible computer readable medium configured to store at least executable instructions. The executable instructions, when executed by a processor of a computing device, cause the computing device to perform functions including: determining one or more representations of sequence features of a reference genome; assessing a set of possible target arms that meet one or more design criteria for a MIP in matching the one or more representations of sequence features; for each possible pair of target arms in the set of possible target arms that meet the one or more design criteria: determining MIP performance data features for the pair of possible target arms, and determining a score for the pair of possible target arms using a MIP performance model operating on the MIP performance data features for the pair of possible target arms; determining a subset of the set of possible target arms that collectively tile all of the one or more representations of sequence features, where the subset is determined based on the scores for the set of possible target arms; determining a set of designed MIPs based on the subset of the set of possible target arms that tile each of the one or more representations of sequence features; and providing an output including information about each designed MIP of the set of designed MIPs.

The herein-described devices, methods, and techniques provide for testing MIP design for a genetic sequence of interest using a computer prior to utilizing a MIP in an in vitro or in vivo environment. In particular, MIP designs that have poor read performance can be screened out, thereby increasing the likelihood of MIPs that read on a genetic sequence of interest. In many situations, computer-based MIP design techniques can be faster, cheaper, and easier to use than in vitro/in vivo techniques, thus the herein-described devices, methods, and techniques can improve speed, cost, and ease of MIP design. Use of the herein-described devices, methods, and techniques can broaden the utility of MIPs for cost-effective targeted sequencing for candidate gene validation as well as for diagnostic sequencing in a clinical setting.

### BRIEF DESCRIPTION OF THE DRAWINGS

FIG. 1 is a flow chart illustrating a method of training one or more MIP performance models, in accordance with an embodiment;

FIG. 2 is a flow chart illustrating a method of designing MIPs, in accordance with an embodiment;

FIG. 3 has four heat maps illustrating interactions of selected MIP parameters and MIP capture efficiency, measured in average read depth (heat), in accordance with an embodiment;

FIG. 4 illustrates a heat map showing targeting arm lengths versus sequencing depth, in accordance with an embodiment;

FIG. 5 is a graph showing read depth per MIP as a function of insert size, in accordance with an embodiment;

FIG. 6 is a graph indicating an effect of 3′ nucleotides on MIP capture efficiency, in accordance with an embodiment;

FIG. 7 is a graph indicating an effect of tandem repeats on MIP read depth, in accordance with an embodiment;

FIG. 8 graphically illustrates Logistic Regression and SVR model performance on both the original assay of MIPs and the redesigned assay of MIPs, in accordance with an embodiment;

FIG. 9 is a graph illustrating concordance between logistic and SVR scoring, in accordance with an embodiment;

FIG. 10 is a graph illustrating uniformity of per MIP read depth before and after redesign, in accordance with an embodiment;

FIG. 11 depicts a graph illustrating effects of rebalancing and overnight shearing on smMIP coverage, in accordance with an embodiment;

FIG. 12 depicts a graph illustrating effects MIP repooling and template shearing on MIP score concordance, in accordance with an embodiment;

FIG. 13 is a bar chart showing coverage thresholds for competing target enrichment strategies on a per gene basis, in accordance with an embodiment;

FIGS. 14A and 14B are charts showing percentages of covered bases related to genes associated with Acute Myeloid Leukemia (AML), in accordance with an embodiment;

FIG. 15A is a bar chart of comparing performance of an original pool of oligonucleotides with a rebalanced pool of oligonucleotides, in accordance with an embodiment;

FIG. 15B is a graph comparing performance of MIPs before and after rebalancing, in accordance with an embodiment;

FIGS. 16A and 16B are charts showing percentages of covered bases for original and rebalanced pools of oligonucleotides, in accordance with an embodiment;

FIGS. 17A and 17B are charts showing percentages of covered bases using hybridization and rebalanced pools of oligonucleotides, in accordance with an embodiment;

FIG. 18 shows on-target read percentages for hybridization and MIP-based techniques, in accordance with an embodiment;

FIG. 19A is a block diagram of an example computing network, in accordance with an embodiment;

FIG. 19B is a block diagram of an example computing device, in accordance with an embodiment; and

FIG. 20 is a flow chart of an example method, in accordance with an embodiment.

### DETAILED DESCRIPTION

Herein are disclosed techniques and devices for designing MIPs using MIPgen, which is an algorithm for predicting MIP performance based on empirically trained logistic and support vector regression models. The literature indicates that MIPs have proven successful in a broad range of applications; e.g., targeted genotyping, DNA sequencing, assessing copy number and content, methylation patterns, RNA allelotyping, and detection of bacteria in clinical samples. MIPs have several advantages, such as low amortized cost per sample and high scalability, which may allow it to replace Sanger sequencing for clinical purposes.

However, in some scenarios, MIPs can be relatively inaccurate and have low sensitivity for detecting low frequency alleles. These deficiencies can be addressed using single molecule MIPs (smMIPs). However, use of smMIPs does not address another MIP limitation: non-uniformity of capture efficiencies within probe sets.

To improve capture efficiencies and for other reasons, we describe MIPgen, an empirically-trained algorithm for designing MIPs. MIPgen was developed with the goal of optimizing performance and reducing reliance on empirical testing for effective MIP repooling. To train MIPgen, an unbiased set of targets in the human exome was selected to generate two statistical models for MIP performance. The predictive power of these models was successfully tested on independent MIP sets.

To build MIPgen, the models for MIP performance were integrated into a design pipeline. MIPgen was validated by head-to-head comparison to our earlier algorithms. Analysis of the resulting sequence data demonstrated substantially improved performance using MIPgen. In one example, MIPgen has been used to redesign a MIP panel targeting nine human genes and achieve improved uniformity relative to former approaches, reducing the coefficient of variation of read depth per site from 0.962 to 0.830 and increasing the median proportion of sites in a sample meeting per-base coverage thresholds from 98.4% to >99.9%.

The herein-disclosed techniques and devices can ease MIP and smMIP assay design while leading to higher quality assays. By automating MIP design, the herein-described techniques and devices can speed the MIP design process and therefore lower the costs to design MIPs for one or more target sequences. Further, the higher quality, cheaper, and automatically designed assays can lead to broader adoption of MIP based genetic matching and sequencing.

### Training MIP Performance Models

The MIPgen algorithm includes models for predicting MIP performance. Training of these models was based on a large unbiased dataset linking single stranded MIP oligonucleotide design features to relative performance in a targeted resequencing experiment.

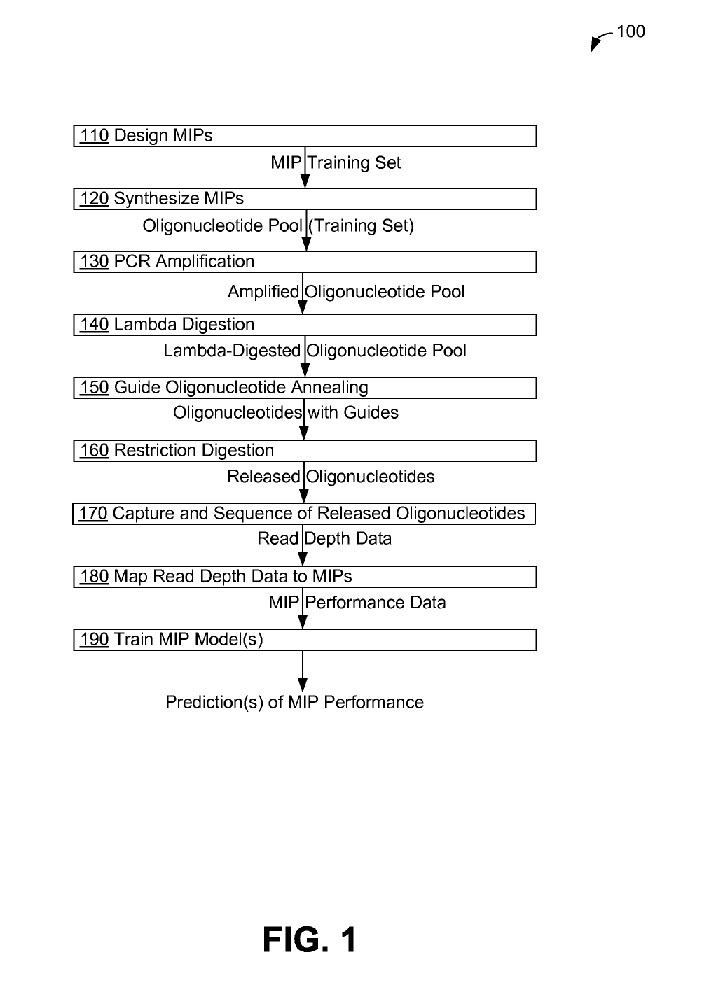

FIG. 1 is a flow chart illustrating method 100 of training one or more MIP performance models, in accordance with an embodiment. Method 100 can begin at block 110, where a training set of MIPs can be designed around randomly selected positions on the plus strand of the human exome. During design, restrictions on targeting arm melting temperature can be ignored. For an example, 12,000 MIPs were designed with each targeting arm randomly selected to be within a base pair (bp) length range; e.g., in the range of 15-30 bps. The sum of the targeting arms and insert size can be similarly selected to be within a separate base pair length range; e.g., a range between 120 and 250 bp. MIP targets can be selected to avoid common single nucleotide polymorphisms (SNPs). For example, common SNPs can be determined by utilizing a reference database, such as dbSNP, and then avoided during design.

At block 120, the designed MIPs can be synthesized. The CustomArray 12K microarray can be used for MIP synthesis. For example, 20 bp PCR adapters with NlaIII and StyD41 restriction sites can be used as flanking sequences to enable amplification of microarray-synthesized oligonucleotides. A pseudorandom sequence; e.g., a homopolymer restricted to four bases in length, can be appended to these sequences as useful to produce a set of 130-mers for testing using the CustomArray microarray. Continuing the above example, an oligonucleotide pool of 12,000 130-mers was synthesized based on the CustomArray microarray for use as the MIP training set.

At block 130, the oligonucleotide pool representing the MIP training set can be amplified. For example, PCR amplification of the microarray-derived oligonucleotide pool can be performed with unphosphorylated and phosphorylated strands for designed MIP sequences and the complementary strand, respectively.

At block 140, the amplified oligonucleotide pool can be subjected to lambda exonuclease (NEB) digestion for selectively degrading the complementary strand of the oligonucleotide pool, leading to a pool of lambda-digested oligonucleotides. At block 150, guide oligonucleotides for restriction, such as NlaIII and StyD41 can be annealed to oligonucleotides in the pool of lambda-digested oligonucleotides.

At block 160, the oligonucleotide pool with annealed guides can be subject to restriction digestion to release the oligonucleotides from the guides. The released oligonucleotides can be subject to size restriction; e.g., only oligonucleotides in a predetermined size range, such as a 60-mer to 90-mer range, are selected to pass size restriction. Size restriction can be used to exclude digested DNA products from the released oligonucleotides

At block 170, capture and sequencing of the released oligonucleotides on a reference genome can be performed. Capture of an oligonucleotide can include matching the oligonucleotides with a complementary strand of the reference genome. When such matching occurs, the oligonucleotide, or a MIP that contained the oligonucleotide, can be said to have read the genome. PCR products were pooled at equal volume, subjected to an Ampure bead cleanup at a 0.8× bead volume ratio, and submitted for sequencing on the Illumina MiSeq platform. Validation MIP captures for comparing original and redesigned MIP sets were performed in quadruplicate. MIP captures were performed as previously described with a MIP to genome ratio of 800:1 for validation captures and 200:1 for training data, with the exception of Stoffel Fragment being replaced by 0.32 uL of NEB Hemo KlenTaq (cat#: M0332S) per capture reaction due to commercial discontinuation of Stoffel Fragment. MIP barcoding PCR was also performed using 5 uL of capture reaction per sample. For example, capture and sequencing can be performed on the Illumina MiSeq for a reference genome represented as a Promega human male gDNA (cat#: G1471). The MiSeq can generate information about the capture, including read depth data.

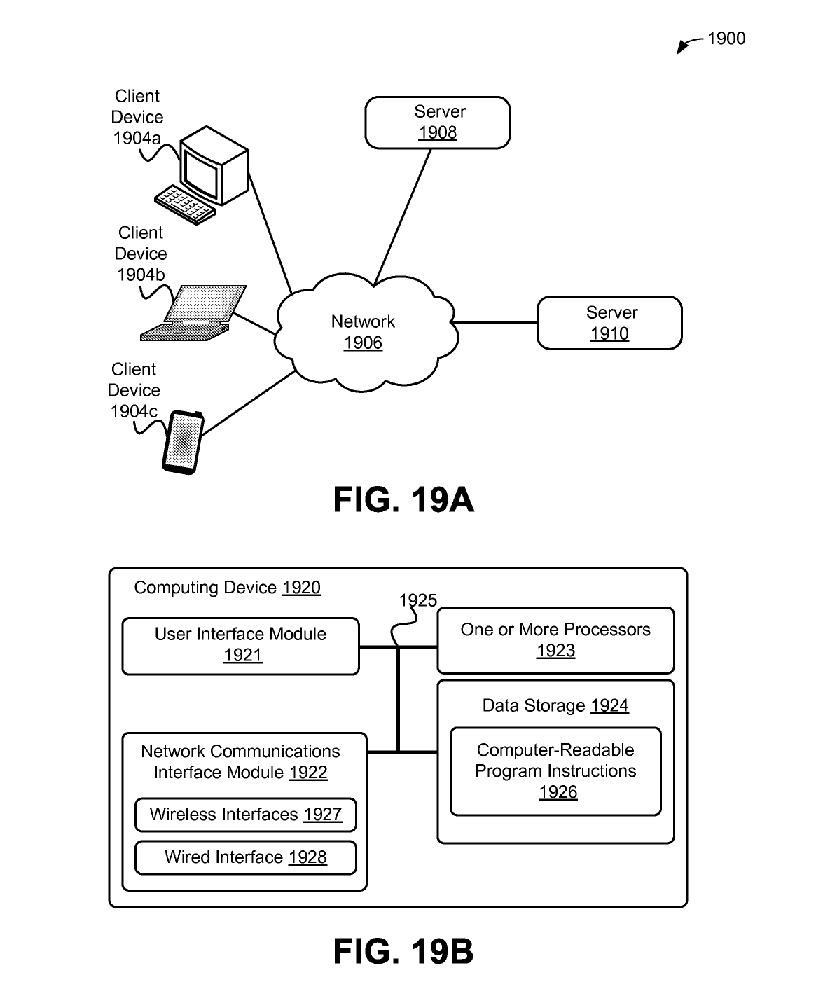

At block 180, the read depth data can be mapped to MIP target sequences to generate MIP performance data 190; e.g., using a computing device such as computing device 1920 discussed below in the context of FIG. 19B. For example, reads for the validation captures can be mapped to the reference genome and tallied based on proper pairs' mapping start coordinate to assign determine each MIP's read depth. When replicates for the training data across different days and different inputs show high correlation, they can be merged into a single measure of read depth. Sequence data for the training set can be mapped to an index generated from the expected MIP targets with the Burrows-Wheeler Aligner (BWA) software package. Then MIPs can be determined from the index of MIP targets. Also, read depth data for MIP targets in the index can be determined, enabling mapping of read depth data to MIPs via the index of MIP targets and so generating the MIP performance data.

Relative MIP performance can be determined by read depth per MIP from properly paired mapping reads. For example, the following technique can enable a computing device to determine read depth, represented as a number of unique capture events u, for a MIP whose sequence alignment data is stored in an alignment file; e.g., a file in SAM or BAM format:
Data for target sequences is provided to the computing device.
The computing device can linearly traverse a data file representing MIP alignment with respect to the reference genome, one record at a time; e.g., a BAM or SAM file.
The computing device can discard reads not classified as properly paired and on target. On target pairs must have both reads mapping to the expected position within a range of a configurable number of nucleotides; e.g., a range within two positions of the expected position.
After these filters, the computing device can parse CIGAR strings of each read to determine insertion, deletions, etc. between the MIP and the reference genome, and fields of the SAM line (namely, start coordinate, CIGAR, sequence, quality and ultimately template length) can be edited to remove MIP targeting arms.
Reads are retained in memory of the computing device until passing the expected coordinate of start of the second targeting arm, by which point the pair of target arms for the MIP has been processed or the paired read is not on target.
At this point, tag defined read groups (TDRGs), which may be further stratified by a sample barcode, can be represented either by a read selected at random or by first determining the most frequent CIGAR pattern and drafting a SMC-read determined by a user of the computing device.
Once all TDRGs have been processed for the MIP site, the computing device can move to the next record in the data file
Once total and unique reads have been tallied across samples and smMIP targets, the number of unique capture events (or TDRGs) u can be estimated by the computing device using Equation 1 below under an assumption that all MIPs in the oligonucleotide pool are amplified uniformly during PCR.

$$u = n \cdot ( 1 - {( 1 - \frac{1}{n} )}^{t} ) \qquad ( 1 )$$

where: t is the total number of reads in the pool and n is the total number of unique capture events. The value of n can estimated from this equation by using numerical methods; e.g. methods available in the SciPy library of scientific tools.

For the 12,000 MIP example mentioned above, read depth of each of the 12,000 MIPs in the MIP training set can be used as a proxy for MIP capture efficiency. The MIPs in the top percentile or with a targeting arm possessing a copy number higher than 100 were filtered out to reduce the effects of outliers, leaving 11,594 MIPs for model building. The read depth information and information about the MIPs mapped to the read depth information can be used as MIP performance data for training the models.

At block 190, the MIP performance data can be used to train one or more models for predicting MIP performance, such as, but not limited to, a model utilizing logistic regression and a model utilizing support vector regression (SVR). For the 12,000 MIP example mentioned above, two models for predicting MIP performance were constructed from the resulting data from the performance of the resulting 11,594 of the 12,000 MIPs: a model utilizing logistic regression and a model utilizing SVR. Features drawn from the targeted sequences included the overall nucleotide composition for each of the targeting arms and the insert region, the bases of the ligation junction, and the copy number of each of the MIP targeting arms. Finer levels of nucleotide composition such as dimer and trimer content were reserved for the SVR model to guard against overfitting as indicated in Table 1 below.

TABLE 1

| | MIP Performance Data Features | | | | |
|---|---|---|---|---|---|
| | MIP | Nucleotide | Copy | | Base |
| Model | Element | Composition | Number | Size | Identity |
| Logistic | Extension | G or C, G, A | log10 | + | — |
| | Ligation | G or C, G, A | log10 | + | First two |
| | | | | | bases |
| | Insert | G or C, G, A, | — | + | — |
| | | alternatives¹ | | | |
| SVR | Extension | monomers, dimers | log10 | + | — |
| | Ligation | monomers, dimers | log10 | + | First two |
| | | | | | bases |
| | Insert | monomers, dimers, | — | + | — |
| | | trimers | | | |
| | Context | monomers, dimers, | — | − | — |
| | | trimers | | | |

¹Average number of alternations between strong (G or C) and weak (A or T) nucleotides per base

The logistic regression model was constructed using the statistical computing software package R. MIP features extracted from target MIP sequences in the MIP performance data included nucleotide composition, a copy number to the human reference genome, identity of the ligation junction bases and target size as shown in Table 1 above. To perform logistic regression, each successive read in excess of one read per replicate was coded as a success whereas each MIPs that failed to reach this threshold was coded as a single failure. All features and their second-degree interactions were used and weakly covariate terms were dropped in accordance with the Akaike information criterion, leading to a series of coefficients for explanatory variables of the logistic regression model. That is, the logistic regression model was trained; i.e., the coefficients for explanatory variables, based on the MIP performance data generated at block 180.

The SVR model was constructed using the software package LIBSVM. Outliers were filtered as indicated above for the logistic regression model. Features extracted from target sequences in the MIP performance data were derived from nucleotide composition, copy number to the human reference genome, identity of the ligation junction bases and target size as indicated in Table 1 above. The labels for each MIP comprised of log-transformed read depth supplemented with a predetermined pseudocount; e.g., a pseudocount of 0.05. LIBSVM's grid search was used with default parameters to select optimal learning metrics for an epsilon-insensitive SVR model with a radial basis kernel. This epsilon-insensitive SVR model can be considered to be a trained SVR model that was trained on the MIP performance data generated at block 180.

Once trained, the logistic regression model and/or SVR model can be applied to predict performance of one or more new MIP oligonucleotides. Software can determine the above-mentioned MIP features for the new MIP oligonucleotide(s) and provide that data to the trained logistic regression model and/or the trained SVR model, along with a new target genome sequence for the new MIP oligonucleotide(s). The trained logistic regression model and/or the trained SVR model can predict the relative performance of the new MIP oligonucleotide(s) in reading the new target genome sequence without use of additional empirical data.

### The MIPgen Algorithm for Designing MIPs

The MIPgen algorithm can facilitate optimized MIP sequence design based on the models developed, with both simplified user input and high extensibility. As initial inputs, MIPgen takes an indexed reference genome, a desired range of target sizes for MIPs, and one or more target sequence specifications, where each target sequence specification indicates a targeted region of the indexed reference genome. For examples, the range of target sequences can be specified in terms of base pairs; e.g., from 120 to 250 bp, and the target region specifications can be specified in BED format and extended based on user input. Sequences corresponding to the targeted regions of the indexed reference genome can be pulled from the reference genome; e.g., from data from a FASTA or similarly formatted file specifying the indexed reference genome or from a software package such as SAMtools.

In some examples, a targeted sequence can have more base pairs than a maximum target size, and so multiple MIPs can be required. For example, if a targeted region has 1000 bps and the desired range of target size ranges from 150 to 200 bp, then at least 5 MIPs would be used to match the entire targeted sequence. In this example, the 5 (or more) MIPs can be said to tile, or cover, the targeted sequence.

To prepare for tiling targeted sequences with MIPs, queried target sequences can be divided into sequence features that are sufficiently far apart to avoid unwanted redundancy of capture, either from adjacent targets or alternate records for the same target. The following techniques can be applied to each sequence feature:
Data for SNPs in the sequence feature can be determined from data from a VCF or similarly formatted file specifying SNPs for the sequence feature or from a software package such as Tabix. The SNP data can be used to preferentially place probe arms of a designed MIP in non-polymorphic sites.
All possible targeting arms and insert sequences for the sequence feature can be tested for copy number to the reference genome using BWA, and characteristics from all possible combinations of targeting arms are calculated for scoring by either the trained logistic regression model or the trained SVR model.

MIP selection is guided by scoring and continues until all targeted bases for all target sequences have been tiled. In the event that a targeted sequence cannot be tiled; e.g., due to low complexity or low specificity, data about the untiled positions for the targeted sequence can be output in addition to the probes selected to partially tile the target sequence. For example, the untiled positions can be output to a BED-formatted file. Tiling of targeted sites, degenerate molecular tags, and the stringency of prioritizing low scoring regions can change MIP tiling. By iterating over the targeted sites and simultaneously traversing sequences while selecting probe designs, an optimal MIP tiling that covers all targeted bases can be produced.

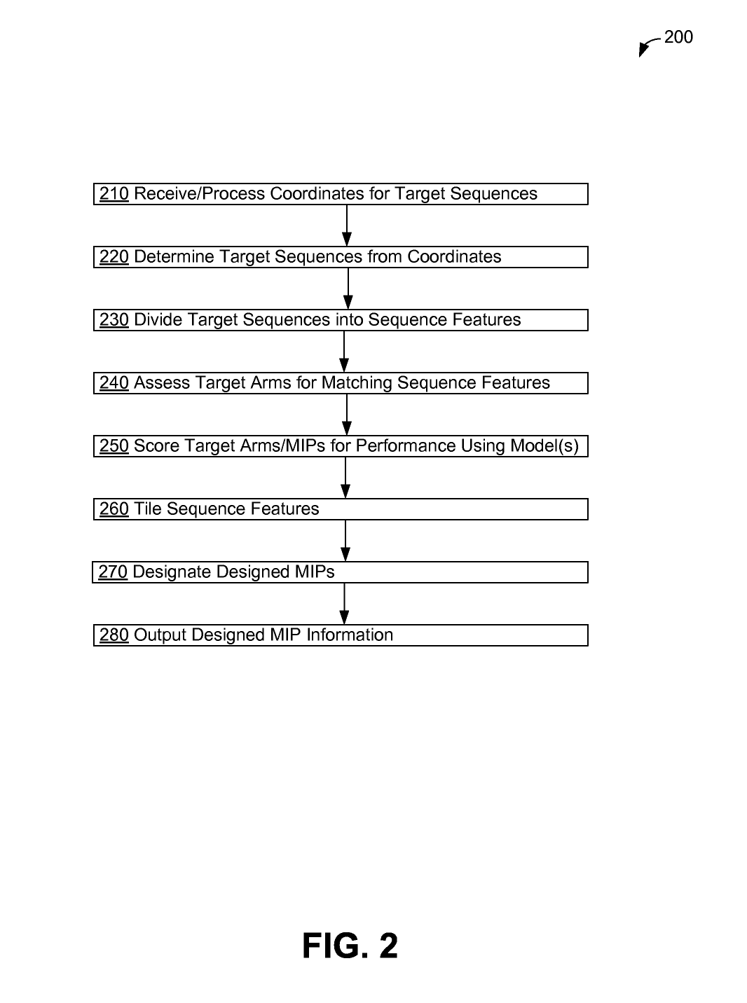

FIG. 2 is a flow chart illustrating method 200 of designing MIPs, in accordance with an embodiment. Method 200 can begin at block 210, where genomic coordinate inputs are received and processed at a computing device, such as computing device 1920 discussed below in the context of FIG. 19B. In this example, the computing device is configured with hardware and/or software for carrying out method 200; . e.g., hardware and/or software for carrying out the MIPgen algorithm. In some embodiments, the MIPgen algorithm can carry out part or all of method 200.

At block 210, the computing device can receive, parse, sort, and merge genomic coordinates for one or more target sequences of an indexed reference genome. The genomic coordinates for target sequences can be specified in BED format; e.g., specifying a name of a target sequence region (name of target chromosome, scaffold, or other sequence region), starting position of the region, and ending position of the region. In some examples, the coordinates can be padded.

Once genomic coordinates are received, the coordinates can be parsed; e.g., if the genomic coordinates are received in BED format, the BED format file can be parsed to determine a starting position and an ending position for each genomic coordinate. Then, the coordinates can be sorted; e.g., in ascending or descending order, and merged. Merging coordinates can involve removing already-specified coordinates and/or joining overlapping coordinates. For example, suppose two genomic coordinates are specified using (starting position, ending position) format as: (1, 100), (10, 20). Then, the range (1, 100) already specifies the next range (10, 20), and so specification of the range (10, 20) can be removed.

As another example, suppose two genomic coordinates are specified using (starting position, ending position) format as: (1, 100), (50, 125). The genomic coordinate specification of the range (1, 100) overlaps the genomic coordinate specification of the range (50, 125) and so the overlapping ranges can be merged to form a single genomic coordinate specification with the range (1, 125). Other examples are possible as well. In some scenarios, the coordinates can be extended. Relevant common genetic variants, as determined by a configurable frequency threshold, can be retrieved from one or more servers; e.g., from the NCBI servers using the Tabix software package.

In some embodiments, additional data can be determined. For example, configurable parameters such as ranges of MIP target arm sizes, SNP avoidance and low complexity area avoidance flags (e.g., an SNP avoidance flag can be set to YES (or an equivalent value) to avoid SNPs, or set to NO (or an equivalent value) to allow (not avoid) SNPs), maximum and/or minimum numbers of designed MIPs, acceptable minimum, maximum, and/or ranges of MIP scoring values, and/or other configurable data can be specified for use in the remainder of method 200. Configurable parameters can be specified/configured by data stored in one or more input files, by inputs received at a user interface, via a network communication, and/or using other techniques. In particular embodiments, some or all configurable parameters can have default values that method 200 can utilize in the absence of other inputs.

At block 220, the genomic coordinates can be used to retrieve the corresponding target sequences for the indexed reference genome. For example, the target (DNA) sequences can be obtained from a server storing genomic sequence data, a database storing genomic sequence data, a genome browser, or via other means. That is, a query can be provided to the server or database storing genomic sequence data that includes the genomic coordinates of the reference genome. In response, the server or database storing genomic sequence data can send a query response that includes a representation of the genomic sequence that corresponds to the genomic coordinates. For example, suppose a representation of the first 20 base pairs of the genomic sequence for the reference genome is “TCAAGTAAGTTAGATAACCA” and the genomic coordinates specify the range (2, 6) of the reference genome. Then, after a query is made for the genomic sequence corresponding to the (2, 6) range of the reference genome, the query response can include a representation of the second to the sixth base pairs of the reference genome; e.g., “CAAGT”. The “CAAGT” string can then represent the sequence feature corresponding to the (2, 6) range.

At block 230, the target sequences can be divided into sequence features that are sufficiently far apart to avoid unwanted redundancy of capture, either from adjacent targets or alternate records for the same target. In some scenarios, BWA can be used determine the copy number of each sequence feature at every potential starting position. In some scenarios, SNPs can be determined to identify positions for sequence features that should be avoided when placing MIP target arms. For example, the SNPs can be determined by querying a common SNP file using Tabix. In other scenarios, sequence features with low complexity areas are to be avoided by MIP target arms. In these scenarios, software such as the Tandem Repeat Finder can be used to identify low complexity areas. In some embodiments, portions of sequence feature(s) that are unsuitable for mapping can be discarded; e.g., portions of sequence features related to SNPs, low complexity areas, redundant captures, etc.

At block 240, all possible target arms for MIPs can be assessed for ability to match sequence features. A copy number can be determined for each target arm that meets design criteria using BWA. For example, targeting arms can be assessed based on BWA's X0 and X1 flags, where the X0 flag indicates a number of best (or optimal) matches found for a targeting arm with respect to the sequence feature, and where the X1 flag indicates a number of suboptimal matches found for a targeting arm with respect to the sequence feature.

The design criteria can specified using the above-mentioned configurable parameters, such as an SNP avoidance flag for avoiding (or not avoiding) SNPs during MIP design, a low complexity area avoidance flag for avoiding (or not avoiding) low complexity areas during MIP design, a range of MIP target arm sizes from TAmin to TAmax, where TAmin is a minimum size of a target arm specified in terms of base pairs, where TAmax is a maximum size of a target arm specified in terms of base pairs, where TAmin>0, TAmax>0, and TAmax≧TAmin, and perhaps other data.

At block 250, each MIP within the design criteria can be scored by a MIP performance model. That is, each MIP within the design criteria can have a pair of target arms that meet the design criteria as determined in block 240. Note that the MIP performance data features listed in Table 1 can be determined for each target arm generated at block 240. Thus, as the MIP performance data features are available for each target arm of a MIP, each target arm of the MIP can be scored by the logistic regression model and/or the SVR model to predict read performance of the MIP.

At block 260, each sequence feature or target sequence (when not divided into sequence features) can be tiled with target arms for MIP(s). For example, a two-pass tiling technique can be used. By default, method 200 attempts to cover every targeted position with at least one MIP, and target arms are permitted to occupy each targeted position once. Because linear tiling restricts the placement of downstream targeting arms, a first tiling pass prioritizes positions that have no MIPs scoring above a configurable threshold. This maximizes the performance at the sites most likely to drop out.

A second tiling pass then linearly tiles the remaining positions with MIPs. The second tiling pass can include checking the score metric of each MIP from higher to lower scores; e.g., insert sizes, and from no redundant coverage to a configurable maximum number of bases of redundancy in order to achieve a balance between tiling efficiency and coverage of the sequence feature by MIP(s).

Additional sets of redundant positions can be tiled during the second tiling pass; e.g., a nonspecific double tiling of regions, a separate tiling of each strand of the sequence feature. These options are not mutually exclusive, but achievement of redundant coverage is limited by the availability of stranded bases for placing novel MIP targeting arms.

By default, method 200 can attempt to occupy each base by a MIP arm at most once per strand. This behavior can be altered to occupy each position only once irrespective of strand or to enforce offsetting, of targeting arms on positions for which a number of bases on one strand are already occupied, which may offer benefits in the form of more independent specificities of capture. Also by default, MIP capture sequences that match multiple MIP targets exactly, as indicated by the X0 flag, or at least partially, as indicated by the X1 flag, are not chosen in the tiling process.

In selecting MIPs for tiling, MIPs with targeting arms with copy numbers below a predetermined maximum; e.g., a copy number of 20 can be preferred over other possible targeting arms since lack of specificity of targeting arms have been observed to yield little information at the targeted site. In some scenarios, MIPs lacking SNPs in their targeting arms can be preferred over MIPs with SNPs in their targeting arms.

In other scenarios, MIPs selected for tiling that possess common SNP(s) in their targeting arms can prompt the design of an alternate SNP MIP. The alternate SNP MIP can be ordered along with MIPs designed to the reference genome; i.e., without SNPs, if the site is biallelic, or are flagged in the output as not capable of capturing common variations. In still other scenarios MIPs that fail to meet the complexity threshold or do not map uniquely to the reference genome can be flagged and perhaps discarded.

The second tiling pass can be completed, and one or more MIPs can be selected to tile the sequence feature. The two tiling passes can be completed for all sequence features of all target sequences.

At block 270, after all target sequences have been tiled, each MIP used in tiling at least part of a target sequence can be designated as a designed MIP.

In some embodiments, the functionality of blocks 250-270 can be performed as indicated below. All possible starting sites meeting the design criteria can be determined, and pertinent DNA sequences can be stored in MIP objects, perhaps managed by Boost smart pointers. In some cases, both plus and minus strands can be processed using identical processing steps for MIPs targeting each strand with only selection of a plus (or a minus) strand being different for the two strands. The copy numbers of the sequences are retrieved and similarly stored in the MIP objects. The information acquired in the MIP objects can be used as inputs to one or more MIP performance models for scoring the probe sequences of the MIP objects. At this point that any sequence containing a genetic variant can be tagged.

In some embodiments, any MIP sequence with a restriction site intended to be used for array-derived oligonucleotides can be tagged. By default, non-uniquely mapping sites in the genome are tagged and discarded. In other embodiments, method 200 can be repeated with a range of capture lengths until a suitable score is found. Then, iterating over all designed probe sequences, the software can output the MIP details and follow a series of criteria to identify condensed MIPs, which are MIPs that either are an optimal MIP for a possible starting position, or an adequately scoring MIP as determined by configurable parameters

These embodiments of method 200 can continue by iterating over all condensed MIP to determine a collapsed MIP, which can be an optimal MIP for a targeted site, and can subsequently output details of the collapsed MIPs. To tile the sequence features, method 200 iterates over all collapsed MIPs and repeatedly selects low scoring MIPs, as determined by user input. Positions scanned by the selected MIPs can be tracked to ensure all targeted positions are ultimately scanned. Positions occupied by targeting arms are tracked to prevent multiple assignments to stranded positions by a MIP.

Once no low scoring positions remain, linear tiling commences on the remaining positions. Starting at the position enabling minimal overlap, the corresponding condensed MIP is assessed, and depending on design criteria, accepted or rejected. A user-defined number of positions are tested before a MIP is either accepted for selection or the highest scoring MIP amongst the rejected MIPs is selected. In particular embodiments, selection behavior can be modified at the end of targeted features to maximize overlap and sequentially test smaller degrees of overlap, so as to avoid the capture of positions outside the targeted feature. At this point every selected MIP can be designated as a designed MIP.

At block 280, information about each designed MIP can be output. Information can include, but is not limited to information about: sequences of target arms, coordinates matched in target sequence(s), target arm sizes, copy numbers, and performance score information. The information can be output by being displayed on a screen or other display device, printed or otherwise output to a file, such as a BED file, or other output medium, rendered using a visualization or other graphical tool, audibly output using a speaker, and perhaps using other output techniques. Positions that remain untiled (or fail to meet redundant coverage) due to unavailability of unoccupied positions or non-unique mapping can be output separately.

In some embodiments, designed MIPs are tested for the presence of genetic variants in the arms. If the variant is a biallelic single nucleotide polymorphism, information about an alternate MIP can be separately output. If the site is more polymorphic, a message noting the failure to design a single alternate MIP can be output.

### Results of MIP Performance Models and the MIPgen Algorithm

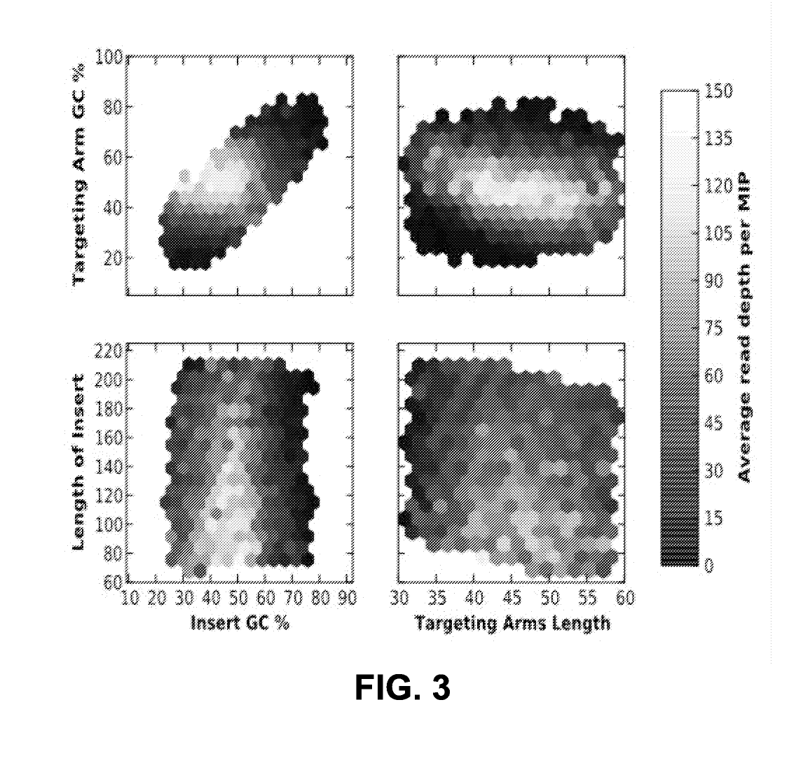

An examination of the two MIP models identified a number of patterns, many of which were suggested by previous work. FIG. 3 has four heat maps illustrating interactions of selected MIP parameters and MIP capture efficiency, measured in average read depth (heat), in accordance with an embodiment. GC content dominates over length of either insert sequence or targeting arms in determining MIP success. MIPs with low GC targeting arms achieve greater success with increasing targeting arm length (upper right), in contrast to MIPs with high GC inserts, which are not significantly aided by modifying MIP insert size, as shown in the lower left heat map of FIG. 3. Importantly, MIPs possessing targeting arms of favorable GC content does not fully protect against unfavorable insert GC content, as shown in the upper left heat map of FIG. 3. Insert size shows little interaction with the length of the targeting arms, as shown in the lower right heat map of FIG. 3.

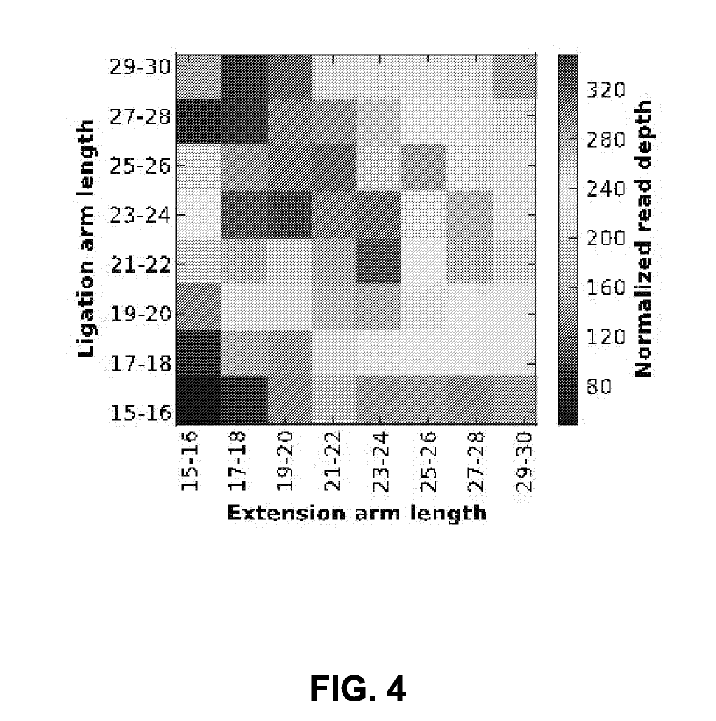

FIG. 4 illustrates a heat map showing targeting arm lengths versus sequencing depth, in accordance with an embodiment. Deviation from the optimal GC content of approximately 45% in either direction resulted in a decline in the number of mapping reads, consistent with previous observations. A total length of 45 bp for the extension and targeting arms was optimal, with deviations in either direction exhibiting reduced performance. Longer ligation arms appear to compensate for short extension arms and vice versa. Ligation arms shorter than 18 bp have poor performance regardless of the length of the extension arm. The identity of the ligation junction (the first two bases from the 5′ end of the MIP oligonucleotide) was confirmed to be significant, showing more than twofold variation in median coverage per MIP across all 16 possibilities.

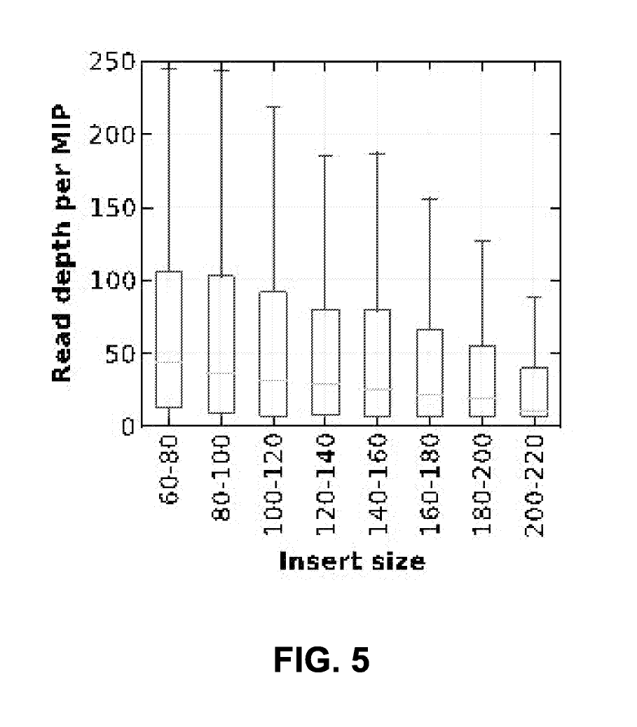

FIG. 5 is a graph showing read depth per MIP as a function of insert size, in accordance with an embodiment. Longer MIP inserts were associated with lower capture efficiencies regardless of targeting arm length or GC content and higher targeting arm copy number to the genome as well as short ligation arms (<18 bp) were strongly associated with MIP dropout. Optimal targeting arm GC content may not compensate for targets in GC content extremes and the contribution to MIP performance of the nucleotide composition of the flanking 2 kb of sequence. The latter indicates significance of factors beyond MIP targeting arm and insert sequence.

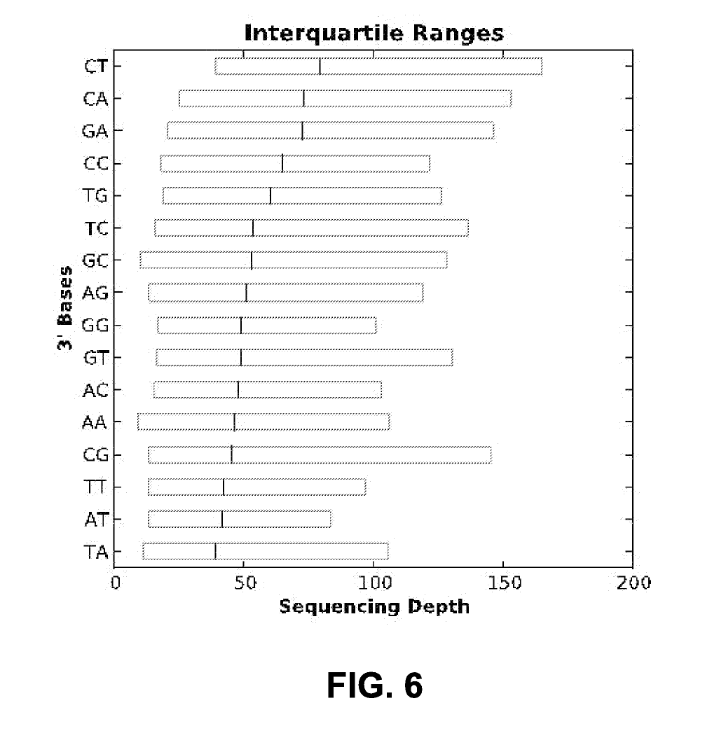

FIG. 6 is a graph indicating an effect of 3′ nucleotides on MIP capture efficiency, in accordance with an embodiment. The identity of the bases 3′ of the ligation arm can lead to as much as a two-fold difference in median read depth per MIP in features that otherwise possessed favorable GC content, as illustrated in FIG. 6. Only MIPs targeting a feature with intermediate GC content (40-50%) are shown. CT dinucleotides 3′ of the intended target are complementary to the common MIP linker sequence, and appear to improve performance of this class of MIP. Otherwise, G and C bases 3′ of the target promote capture above A and T bases.

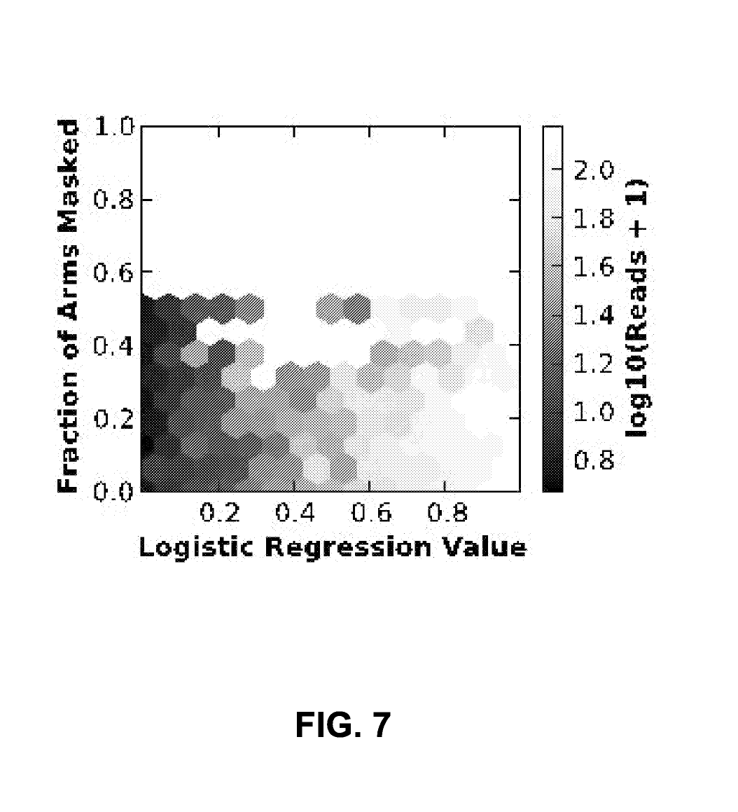

FIG. 7 is a graph indicating an effect of tandem repeats on MIP read depth, in accordance with an embodiment. MIP performance appeared to be unaffected by the presence of tandem repeats (low complexity areas) in MIP arms as calculated by Tandem Repeats Finder within the range surveyed by the training set, as indicated by FIG. 7. Simple tandem repeats were present in a substantial fraction of MIPs in the model training set. More extreme masking of targeting arm bases is not associated with either higher or lower MIP performance when conditioned on the logistic score assigned to the MIP.

A set of nine previously targeted genes (SHANK3, CHD8, TBL1XR1, TBR1, DYRK1A, ADNP, GRIN2B, PTEN, and CTNNB1) was selected to test the models' predictions of MIP performance with and without redesign. An original MIP assay of 408 MIPs was determined, each MIP having target arms fixed to 40 base pairs in length and capture size fixed at 152 base pairs.

The MIPgen algorithm was applied to the same nine previously targeted genes described above to test designs guided by the model-based scores. Targeting arms were allowed to vary from 40 to 45 nucleotides, the size of the targeting arms plus insert was constrained to 162 nucleotides, and linear tiling was restricted to no more than 30 nucleotides of overlapping scan sequence. The resulting design included a redesigned assay of 402 smMIPs with complete tiling of the targeted genes.

The original assay and redesigned assay were both tested on a control genome. First, the MIPs in the original assay were scored based on the logistic regression and SVR models to test model accuracy for predicting performance. Scores were correlated with total read counts for both logistic regression scoring (Spearman rho=0.536) and SVR scoring (Spearman rho=0.540). Special attention was given to MIPs with less than 10% of the average coverage per MIP as such MIPs are largely responsible for gaps in coverage. Both logistic regression (AUC=0.827) and SVR (AUC=0.864) models were successful at detecting low performing MIPs.

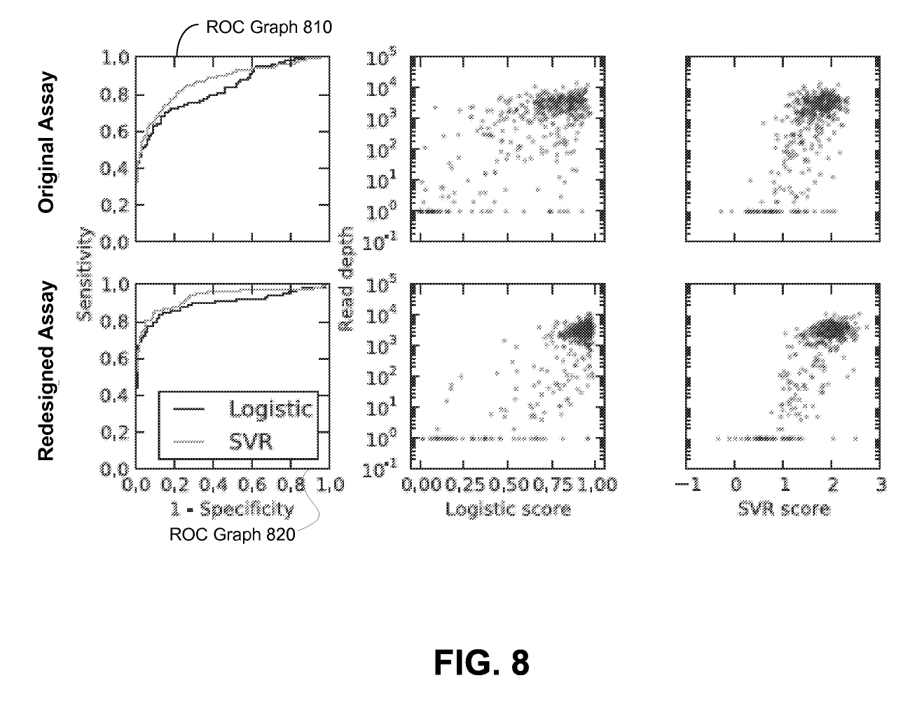

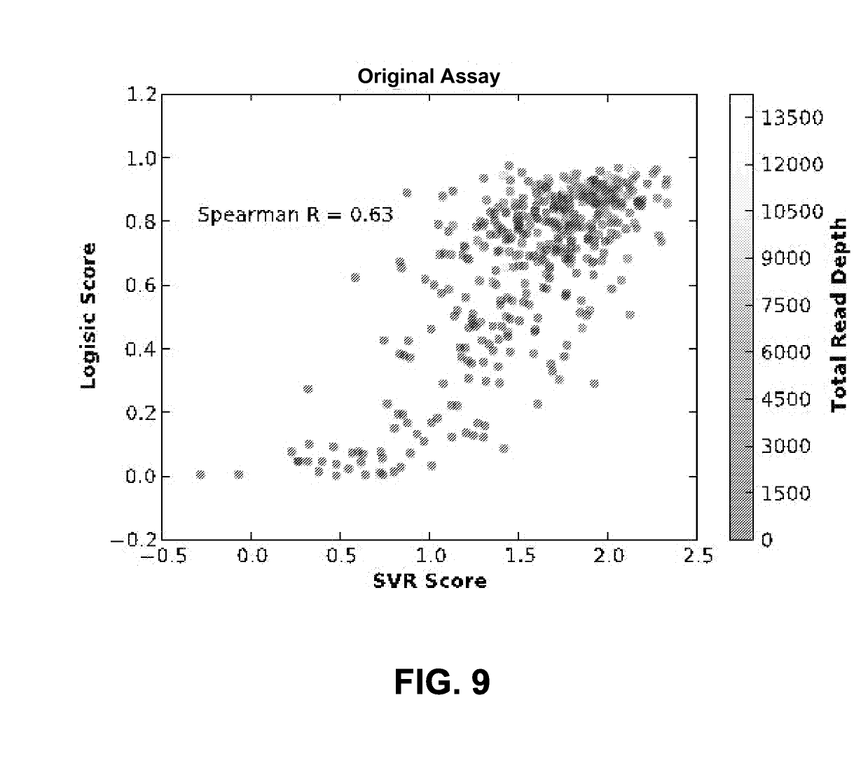

FIG. 8 graphically illustrates Logistic Regression and SVR model performance on both the original assay of MIPs and the redesigned assay of MIPs Model scores predict MIP performance, in accordance with an embodiment. The top row of graphs in FIG. 8 show results for the original assay and the bottom row of graphs in FIG. 9 show results for the redesigned assay. SVR scoring displays slightly greater power to discriminate adequately performing MIPs from poorly performing MIPs for both the original and redesigned MIP assays, as demonstrated in a higher area under curve (AUC) for receiver operating characteristic (ROC) curves 810 and 820. ROC curves 810 and 820 are conditioned on whether a MIP attained at least 10% of the median number of reads per MIP.

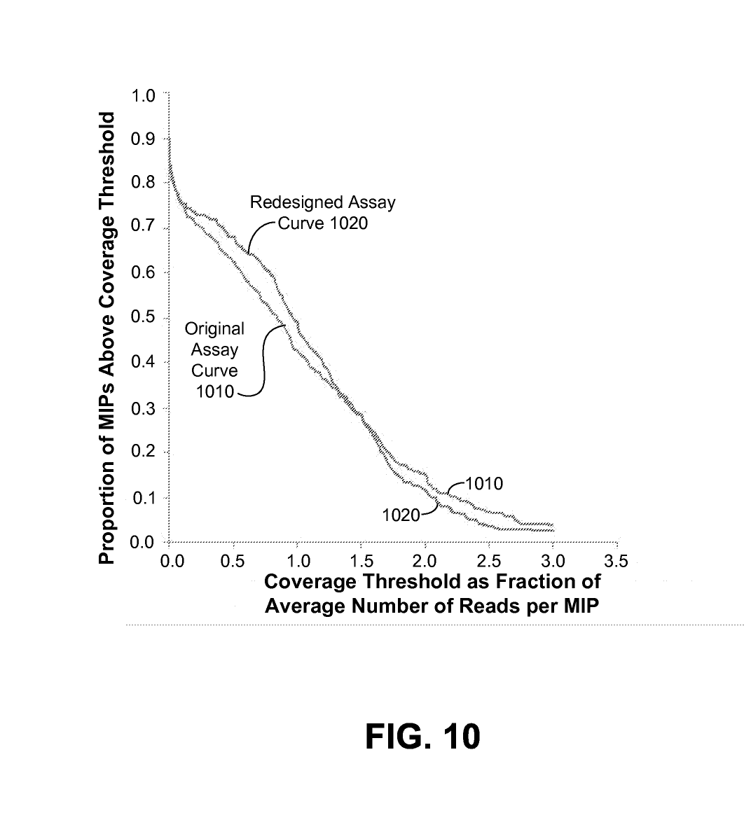

FIG. 9 is a graph illustrating concordance between logistic and SVR scoring, in accordance with an embodiment. Each MIP in the nine gene test set is illustrated in FIG. 10 as a point colored in accordance with the read depths summed across all replicates. The scores from the two competing models are similar but not identical. In particular, logistic regression and SVR scores were only slightly more correlated with each other (Spearman rho=0.63) than with total read depth. Performance of MIPs in the redesigned assay was compared to performance of MIPs in the original assay to ascertain the success of MIPgen. Average coverage per MIP in the redesigned assay increased 18% over the original assay; however, the proportion of the 19,349 targeted bases below 10% of the median per-base coverage (2668X) of the replicates remained unchanged: 23.7% for the original assay and 23.8% for the redesigned assay.

FIG. 10 is a graph illustrating uniformity of per MIP read depth before redesign as original assay curve 1010 and after redesign as redesigned assay curve 1020, in accordance with an embodiment. Ideally, the read depth per MIP would follow a uniform distribution with all MIPs acquiring the average number of reads, and no MIPs acquiring more than the average. However, gaps in coverage arise when the read depth per MIP either does not meet the average or exceeds the average. FIG. 10 shows redesigned assay curve 1020 is initially above original assay curve 1010 indicating improvements below the average, where more sites are acquiring adequate coverage. As the coverage threshold increases on the graph shown in FIG. 10 to exceed the average, redesigned assay curve 1020 goes below original assay curve 1010, indicating fewer MIPs of the redesigned assay are acquiring excessive reads compared to MIPs in the original assay. As illustrated in FIG. 10, uniformity of coverage improved with the redesign. The relative standard deviation of read depth per MIP was reduced from 0.962 for the original assay to 0.830 for the redesigned assay.

Scores continued to correlate with MIP performance in the redesigned assay for both the logistic regression (Spearman rho=0.581) and SVR (Spearman rho=0.638) models, as illustrated in FIG. 8. The power to detect low performing MIPs in the redesigned assay was similarly accurate for the logistic regression model (AUC=0.895) and for the SVR model (AUC=0.926).

Following these first captures, low performing MIPs were repooled at 25 times the original concentration for a subset of the nine genes in the redesigned assay, and head-to-head comparisons of these genes with previous data on the original assay showed improved coverage of poorly captured genes at the per base level, boosting the proportion of sites meeting per-sample coverage thresholds of 20 times for tag-free MIPs and 10 times for SMC-reads by as much as 20%, with the median proportion of sites meeting per-base coverage thresholds rising from 98.4% to over 99.9%.

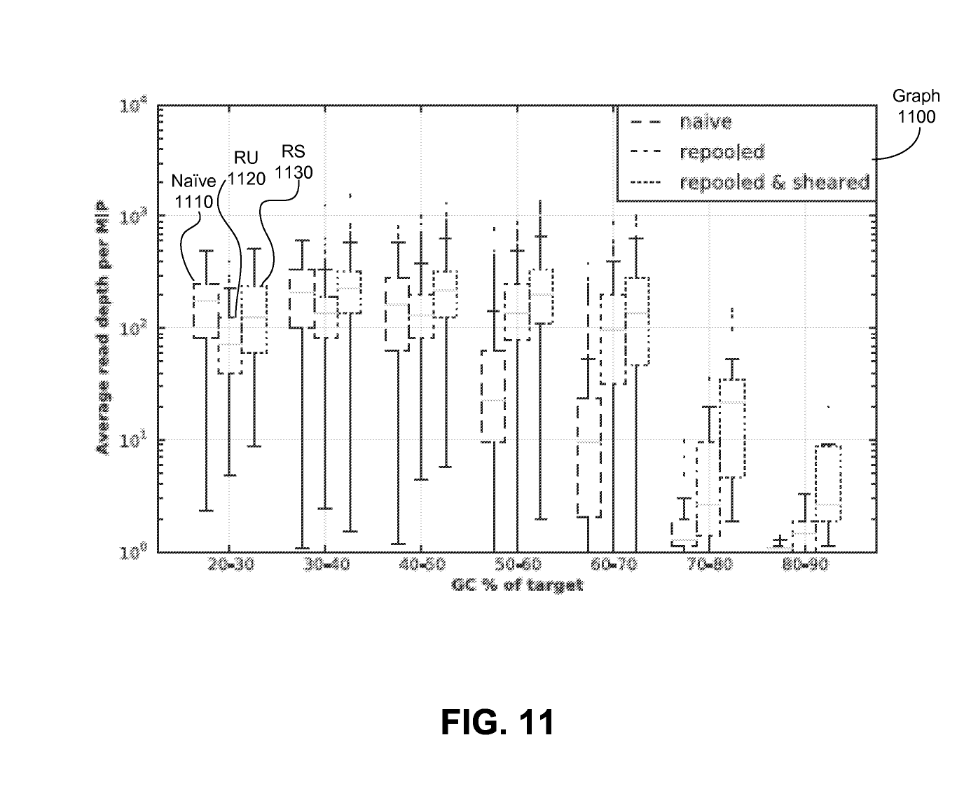

FIG. 11 depicts graph 1100 illustrating effects of rebalancing and overnight shearing on smMIP coverage, in accordance with an embodiment. Shearing protocols substantially mitigated, but did not eliminate, coverage loss associated with poorly performing MIPs, with high GC content remaining as the primary challenge. Graph 1100 shows average read depth per MIP as a function of GC % of target, where the GC % is divided into ranges; e.g., 20-30%, 30-40%, 40-50%, 50-60%, 60-70%, 70-80%, and 80-90%. For each range of GC %, results of the naïve (without repooling) MIP performance, repooled and unsheared (RU) MIP performance, and repooled and sheared (RS) MIP performance are shown in graph 1100. For example, naïve performance bar 1110, repooled and unsheared performance bar 1120, and repooled and unsheared performance bar 1130 indicate respective MIP performance for GC % in the range 20-30%.

An additional smMIP set was designed to a set of targets featuring more sequence in the GC extremes and then used to assess the robustness of MIP scoring and design for sheared gDNA template. High GC smMIP assays benefit from both rebalancing and shearing DNA template prior to capture. Low GC targets are well represented in the MIPgen set. High GC targets continue to pose difficulty for capture even with modifications to MIP design and capture protocols as illustrated in graph 1100.

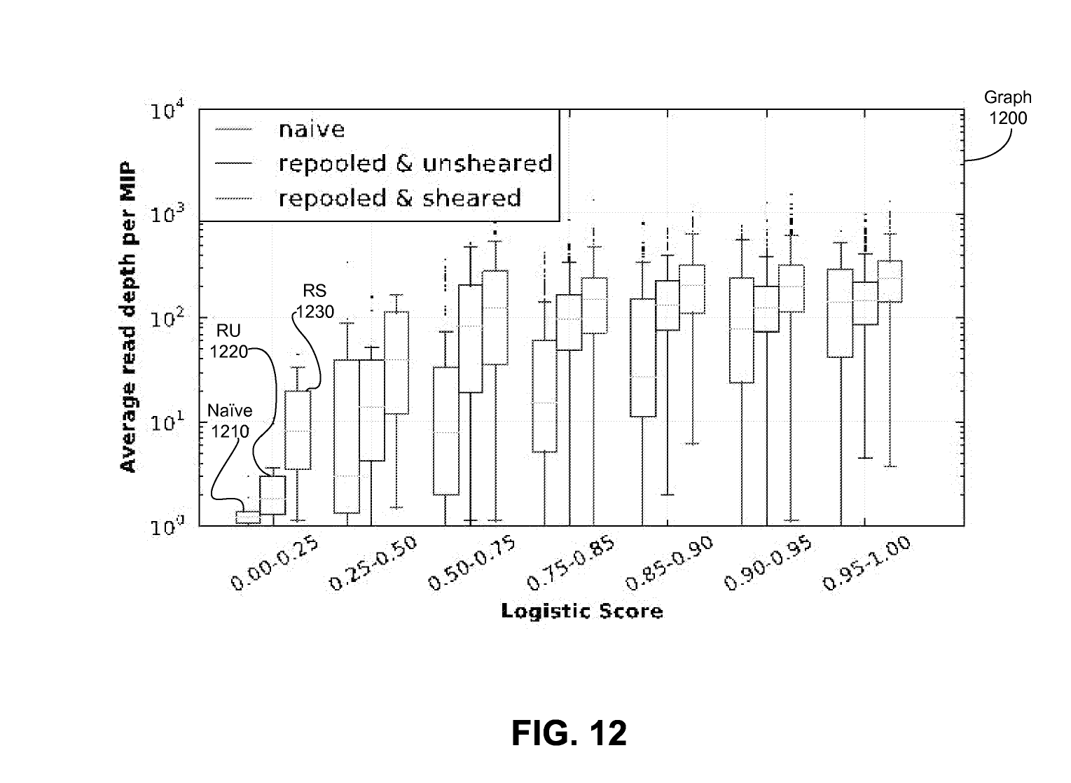

FIG. 12 depicts graph 1200 illustrating effects MIP repooling and template shearing on MIP score concordance, in accordance with an embodiment. Scoring of MIPs remains predictive of low coverage even with MIP repooling and template shearing. Graph 1200 shows average read depth per MIP as a function of target logistic regression model scores, with target logistic regression model scores specified as ranges of scores; e.g., 0-0.25, 0.25-0.50, 0.5-0.75, 0.75-0.85, 0.85-0.90, 0.90-0.95, and 0.95-1.0. For each range of scores, results of the naïve (without repooling) MIP performance, repooled and unsheared (RU) MIP performance, and repooled and sheared (RS) MIP performance are shown in graph 1200. For example, naïve performance bar 1210, repooled and unsheared performance bar 1220, and repooled and unsheared performance bar 1230 indicate respective MIP performance for logistic regression model scores in the range 0 to 0.25.

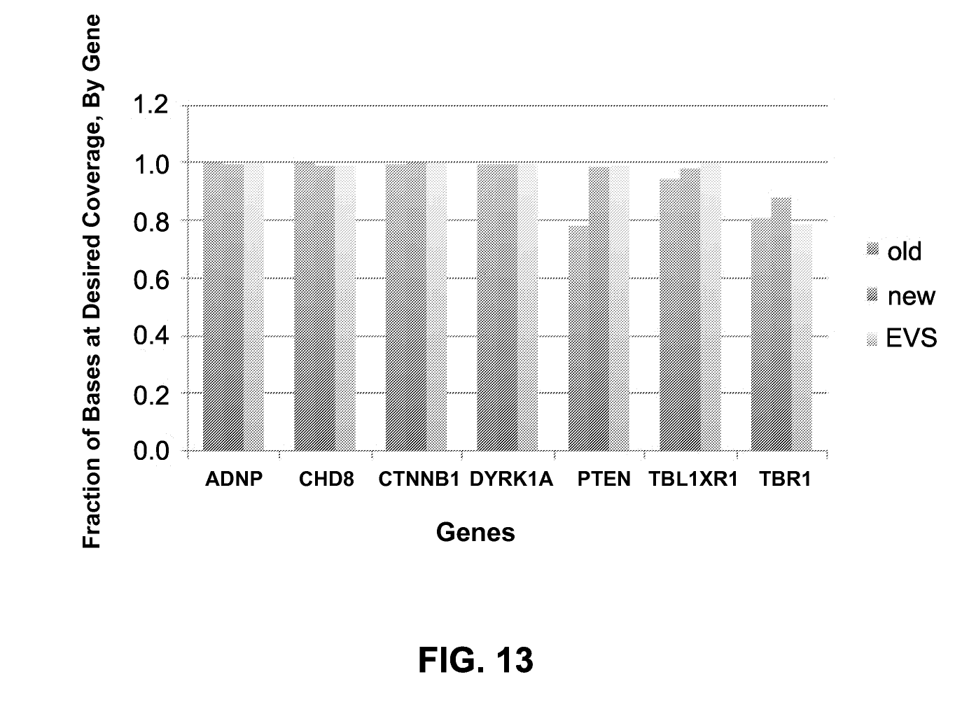

FIG. 13 is a bar chart showing coverage thresholds for competing target enrichment strategies on a per gene basis, in accordance with an embodiment. For each of the seven genes shown in FIG. 13—ADNP, CHD8, CTNNB1, DYRK1A, PTEN, TBLE1XR1, and TBR1—three bars indicating respective fractions of bases at desired coverage for the original or “old” nine-gene MIP assay, a “new” smMIP assay with one read per TDRG, and coverage reported by the Exome Variant Server (EVS). Coverage thresholds were set at 20 times for the old nine-gene MIP assay and 10 times for the new smMIP assay (one read per TDRG) and the EVS. For the smMIP and MIP assays, the median value of the replicates was taken. For all genes, the new smMIP assay more often meets coverage thresholds than the previous MIP assay. The genes that exhibited deficits in coverage for the smMIP assay also underperformed in the EVS. Comparison of MIP coverage at the seven gene sites to coverage levels reported on the Exome Variant Server showed comparable coverage across targeted regions, suggesting that many targets that are problematic for MIP capture are also problematic for hybrid capture and/or for Illumina sequencing.

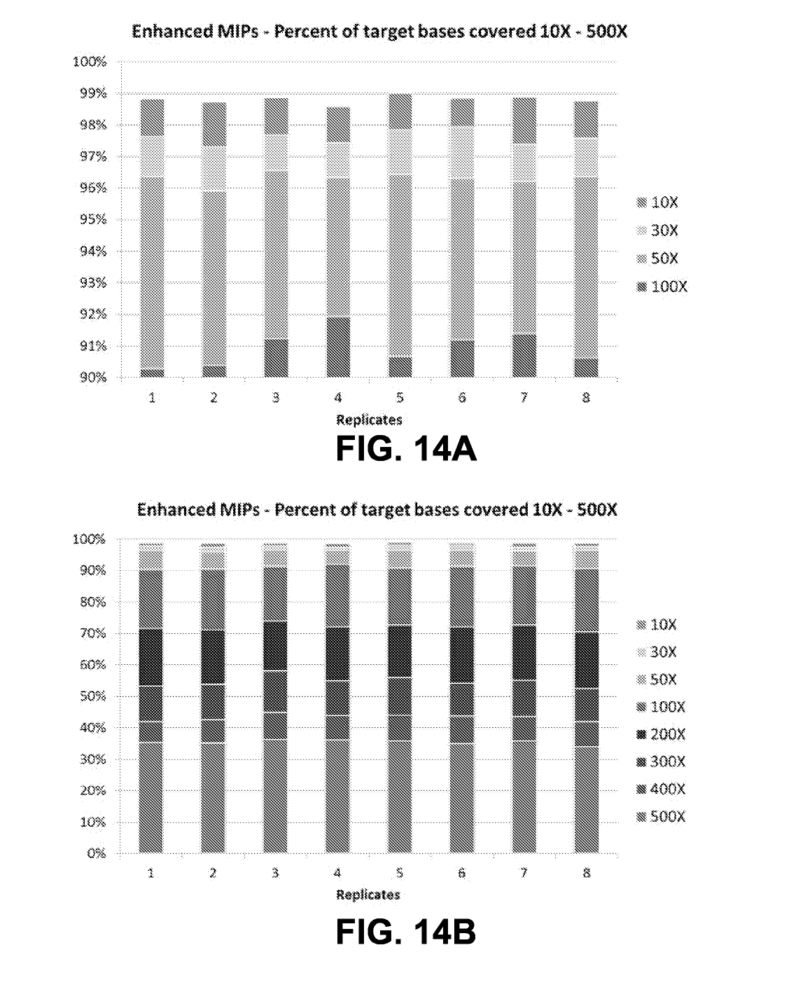

FIGS. 14A and 14B are charts showing percentages of covered bases related to genes associated with Acute Myeloid Leukemia (AML), in accordance with an embodiment. A set of 264 genes related to AML were initially selected from the Cancer Genome Atlas having a total of approximately 1.4 million basepairs. The sequences were derived from studies on 200 patients: 50 were whole genome sequenced, and 150 were whole exome sequenced. Of the initial set of 264 genes, a subset of 12 genes related to AML was selected. The genes in the subset had a total of approximately 70 kilo-basepairs. MIPs were designed to cover the subset of 12 genes and results from 8 replicates, with about 1.2 million aligned reads per replicate, are shown in FIGS. 14A and 14B.

FIG. 14B, in the lower portion of the sheet depicting FIGS. 14A and 14B, concentrates on percentages of covered bases between 0% and 90% for the eight replicates, while FIG. 14A, in the upper portion of the sheet depicting FIGS. 14A and 14B, concentrates on percentages of covered bases between 91% and 100%.

Coverage thresholds from 10 times to 500 times are shown in FIGS. 14A and 14B for each replicate. For example, FIG. 14B shows for replicate 1, about 35% of bases are shown covered by a 500 times coverage threshold, about 41% of bases are covered by a 400 times coverage threshold, and so on until about 90% of bases are shown having a 100 times coverage threshold on FIG. 14B, as well as on FIG. 14A. Then, looking at FIG. 14A for replicate 1, about 96.3% of bases are shown having a 50 times coverage threshold, about 97.8% of bases are shown having a 30 times coverage threshold, and about 98.9% of bases are shown having a 10 times coverage threshold. FIG. 14A best shows that, at a coverage threshold of 30 times, at least 96% of bases are covered for seven of the eight replicates, with replicate 2 having slightly less than 96% of bases covered.

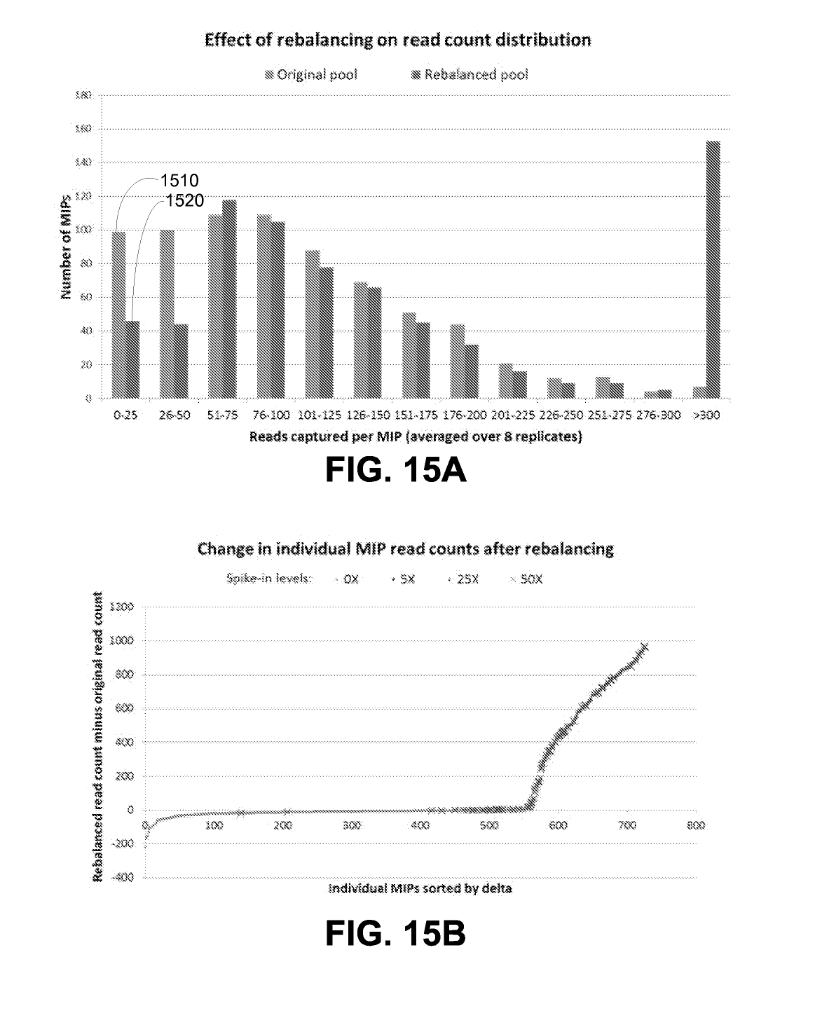

Rebalancing a pool of oligonucleotides, or increasing the concentration of relatively-poorly performing MIPs in sequencing a genome of interest, can increase coverage thresholds without redesigning or resynthesizing MIPs. FIG. 15A is a bar chart of comparing performance of an original pool of oligonucleotides with a rebalanced pool of oligonucleotides, in accordance with an embodiment. FIG. 15A graphs a number of MIPs that had various ranges of reads captured/MIP. For example, bar 1510 of FIG. 15A indicates that about 99 MIPs in the original pool of oligonucleotides captured between 0 and 25 reads, while bar 1520 of FIG. 15A indicates that about 42 MIPs in the rebalanced pool of oligonucleotides captured between 0 and 25 reads.

FIG. 15B is a graph comparing performance of MIPs before and after rebalancing, in accordance with an embodiment. In particular, the graph of FIG. 15B shows MIPs sorted by a change in read performance between use in the original pool of oligonucleotides and the rebalanced pool of pool of oligonucleotides, with about 15 MIPs having read counts that have decreased by at least 60 reads after rebalancing and about 150 MIPs having read counts that have increased by at least 60 reads after rebalancing. The graph of FIG. 15B shows that several MIPs in underrepresented regions have spiked, or increased greatly—spikes are shown in FIG. 15B using “X” marks for spikes of 50 times. Together, FIGS. 15A and 15B indicate that rebalancing can improve uniformity of coverage, but that about 5-10% of MIPs are underperforming.

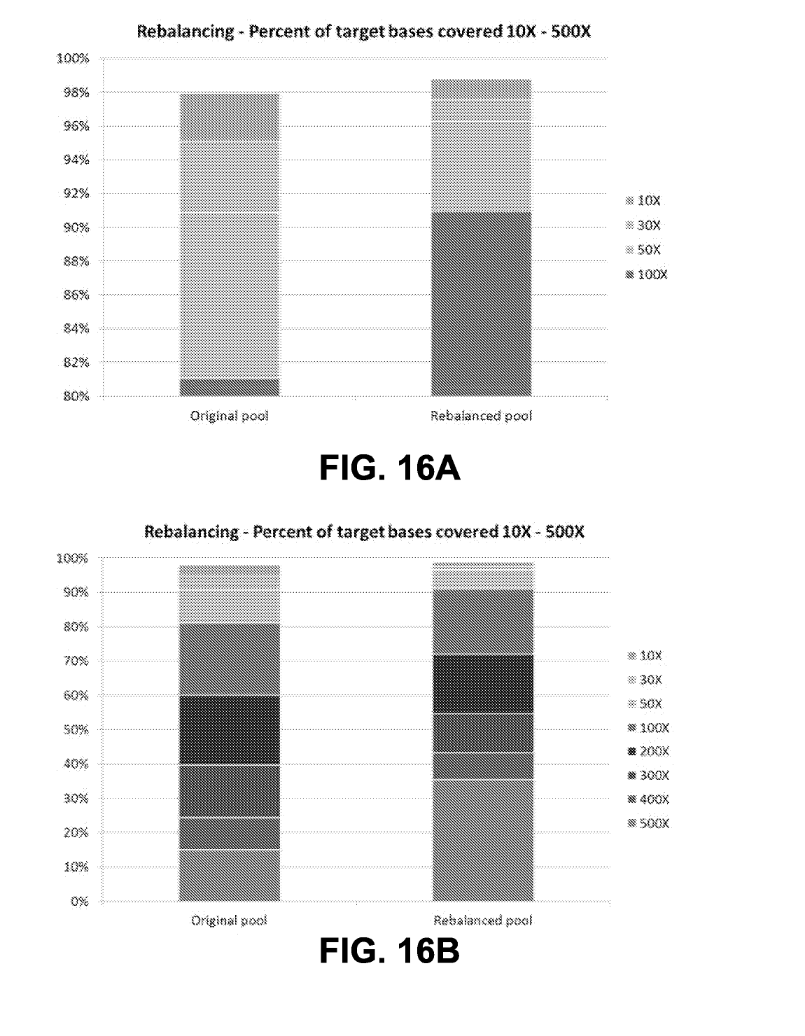

FIGS. 16A and 16B are charts showing percentages of covered bases for original and rebalanced pools of oligonucleotides, in accordance with an embodiment. FIG. 16B, in the lower portion of the sheet depicting FIGS. 16A and 16B, concentrates on percentages of covered bases between 0% and 80% for the eight replicates, while FIG. 16A, in the upper portion of the same sheet, concentrates on percentages of covered bases between 90% and 100%. Varying coverage thresholds from 10 times to 500 times are shown in FIGS. 16A and 16B for both the original and rebalanced pools of oligonucleotides, where the data for FIGS. 16A and 16B is based on about 1.1 million reads for both pools of oligonucleotides

FIGS. 16A and 16B indicates that rebalancing can increase target coverage at a variety of coverage thresholds. For example, FIG. 16B illustrates that, at respective coverage thresholds of 500 times and 200 times, about 15% and 60% of the target bases are covered by the original pool and about 35% and 72% are covered by the rebalanced pool. Further, FIG. 16A indicates that, at respective coverage thresholds of 100, 50, 30, and 20 times, about 81%, 91%, 95.3%, and 98% of the target bases are covered by the original pool, while the rebalanced pool has respectively increased coverage percentages of about 91%, 96.3%, 97.7%, and 99%.

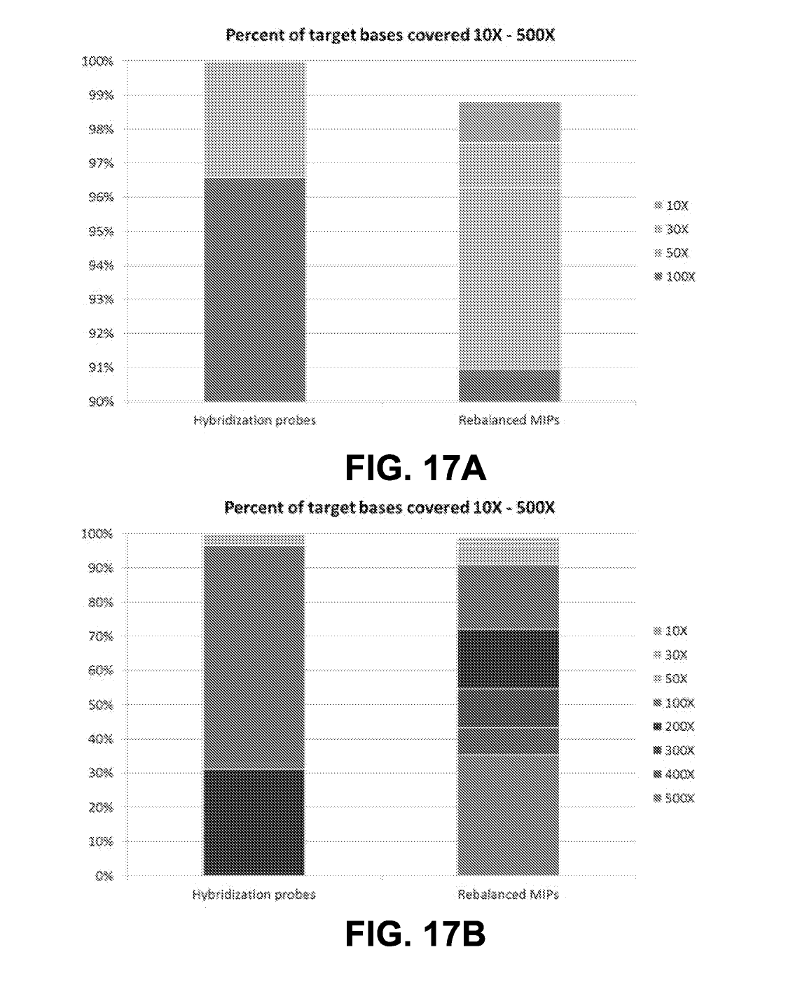

FIGS. 17A and 17B are charts showing percentages of covered bases using hybridization and rebalanced pools of oligonucleotides, in accordance with an embodiment. The data for FIGS. 17A and 17B involved use of a hybridization technique with a 8 sample multiplex with one MiSeq flow cell and a MIP-based technique using the above-mentioned rebalanced pool of oligonucleotides in making about 1.1 million reads per replicate of a 70 kilo-basepair sequence related to AML.

FIG. 17B, in the lower portion of the sheet depicting FIGS. 17A and 17B, concentrates on coverage percentages between 0 and 90%, while FIG. 17A, in the upper portion of the same sheet, concentrates on percentages of covered bases between 90% and 100%. Coverage thresholds from 10 times to 500 times are shown in FIGS. 17A and 17B for both the hybridization-based and MIP-based results. FIG. 17A indicates that at lower coverage thresholds, hybridization can outperform MIPs. For example, at a 30 times coverage threshold, FIG. 17A indicates that hybridization has nearly 100% coverage, while a MIP-based technique has about 97.7% coverage.

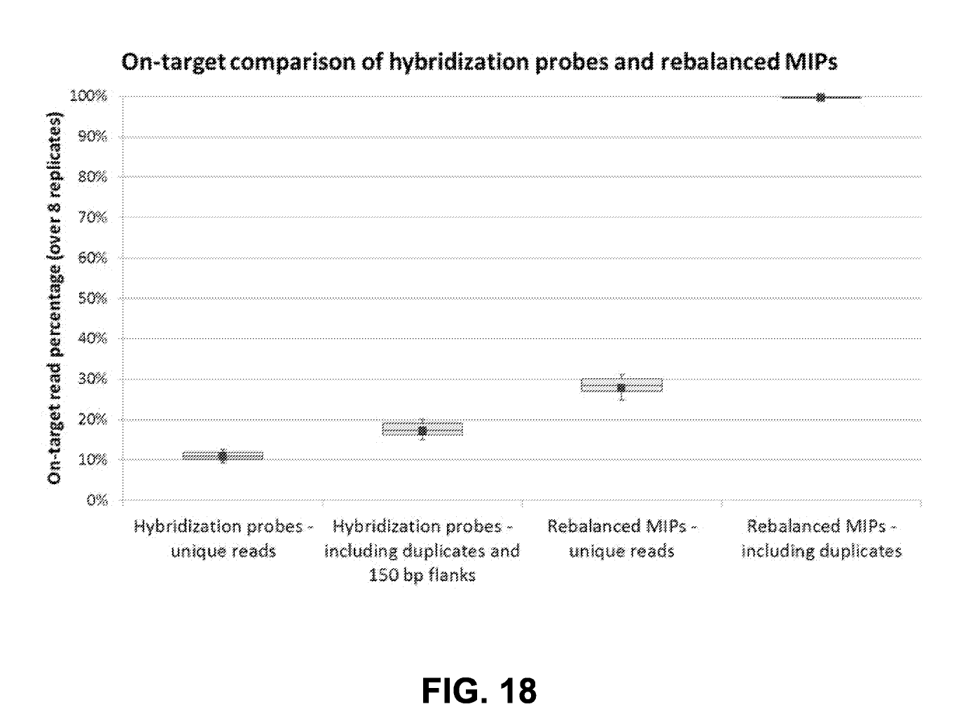

FIG. 18 shows on-target read percentages for hybridization and MIP-based techniques, in accordance with an embodiment. MIP-based techniques can be very specific, and so can provide high on-target read percentages. For example, for the above-mentioned 70 kilo-basepair target related to AML, hybridization techniques can have an on-target percentage of about 20%. In contrast, MIPs with rebalancing designed using MIPgen can achieve nearly 100% on-target percentages. In some embodiments, MIPs can have molecular ID tags to differentiate between unique captured molecules in the sample and amplified replicates.

### Example Computing Network

FIG. 19A is a block diagram of example computing network 1900 in accordance with an example embodiment. In FIG. 19A, servers 1908 and 1910 are configured to communicate, via a network 1906, with client devices 1904a, 1904b, and 1904c. As shown in FIG. 19A, client devices can include a personal computer 1904a, a laptop computer 1904b, and a smart-phone 1904c. More generally, client devices 1904a-1904c (or any additional client devices) can be any sort of computing device, such as a workstation, network terminal, desktop computer, laptop computer, wireless communication device (e.g., a cell phone or smart phone), and so on.

The network 1906 can correspond to a local area network, a wide area network, a corporate intranet, the public Internet, combinations thereof, or any other type of network(s) configured to provide communication between networked computing devices. In some embodiments, part or all of the communication between networked computing devices can be secured.

Servers 1908 and 1910 can share content and/or provide content to client devices 1904a-1904c. As shown in FIG. 19A, servers 1908 and 1910 are not physically at the same location. Alternatively, servers 1908 and 1910 can be co-located, and/or can be accessible via a network separate from network 1906. Although FIG. 19A shows three client devices and two servers, network 1906 can service more or fewer than three client devices and/or more or fewer than two servers. In some embodiments, servers 1908, 1910 can perform some or all of the herein-described methods; e.g., methods 100, 200, and/or 2000.

### Example Computing Device

FIG. 19B is a block diagram of an example computing device 1920 including user interface module 1921, network-communication interface module 1922, one or more processors 1923, and data storage 1924, in accordance with an embodiment.

In particular, computing device 1920 shown in FIG. 19A can be configured to perform one or more functions of client devices 1904a-1904c, network 1906, and/or servers 1908, 1910 and/or one or more functions of methods 100, 200, and/or 2000. Computing device 1920 may include a user interface module 1921, a network-communication interface module 1922, one or more processors 1923, and data storage 1924, all of which may be linked together via a system bus, network, or other connection mechanism 1925.

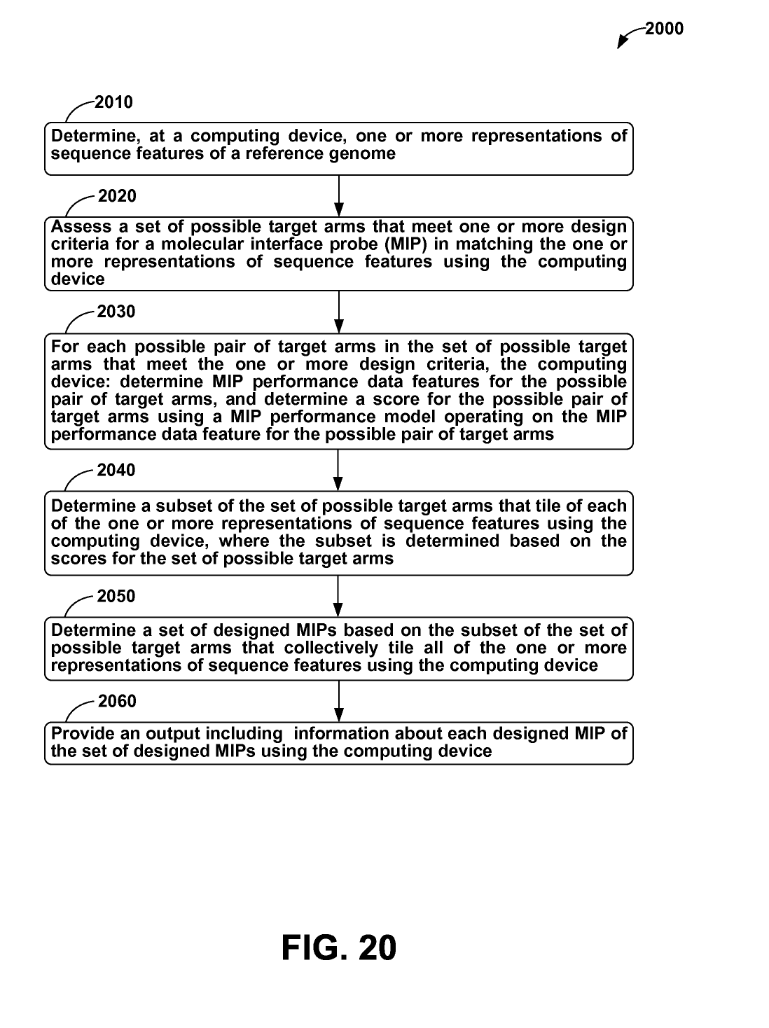

Computing device 1920 can be a desktop computer, laptop or notebook computer, personal data assistant (PDA), mobile phone, embedded processor, touch-enabled device, or any similar device that is equipped with at least one processing unit capable of executing machine-language instructions that implement at least part of the herein-described techniques and methods, including but not limited to: method 100 described with respect to FIG. 1, method 200 described with respect to FIG. 2, and/or method 2000 described with respect to FIG. 20.

User interface 1921 can receive input and/or provide output, perhaps to a user. User interface 1921 can be configured to send and/or receive data to and/or from user input from input device(s), such as a keyboard, a keypad, a touch screen, a computer mouse, a track ball, a joystick, and/or other similar devices configured to receive input from a user of the computing device 1920.

User interface 1921 can be configured to provide output to output display devices, such as one or more cathode ray tubes (CRTs), liquid crystal displays (LCDs), light emitting diodes (LEDs), displays using digital light processing (DLP) technology, printers, light bulbs, and/or other similar devices capable of displaying graphical, textual, and/or numerical information to a user of computing device 1920. User interface module 1921 can also be configured to generate audible output(s), such as a speaker, speaker jack, audio output port, audio output device, earphones, and/or other similar devices configured to convey sound and/or audible information to a user of computing device 1920. In some embodiments, user interface 1921 can be configured with a haptic interface that can receive haptic-related inputs and/or provide haptic outputs such as tactile feedback, vibrations, forces, motions, and/or other touch-related outputs.

Network-communication interface module 1922 can be configured to send and receive data over wireless interface 1927 and/or wired interface 1928 via a network, such as network 1906. Wireless interface 1927 if present, can utilize an air interface, such as a Bluetooth®, Wi-Fi®, ZigBee®, and/or WiMAX™ interface to a data network, such as a wide area network (WAN), a local area network (LAN), one or more public data networks (e.g., the Internet), one or more private data networks, or any combination of public and private data networks. Wired interface(s) 1928, if present, can comprise a wire, cable, fiber-optic link and/or similar physical connection(s) to a data network, such as a WAN, LAN, one or more public data networks, one or more private data networks, or any combination of such networks.

In some embodiments, network-communication interface module 1922 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well as or in addition to those listed herein to secure (and then decrypt/decode) communications.

Processor(s) 1923 can include one or more central processing units, computer processors, mobile processors, digital signal processors (DSPs), microprocessors, computer chips, and/or other processing units configured to execute machine-language instructions and process data. Processor(s) 1923 can be configured to execute computer-readable program instructions 1926 that are contained in data storage 1924 and/or other instructions as described herein.

Data storage 1924 can include one or more physical and/or non-transitory storage devices, such as read-only memory (ROM), random access memory (RAM), removable-disk-drive memory, hard-disk memory, magnetic-tape memory, flash memory, and/or other storage devices. Data storage 1924 can include one or more physical and/or non-transitory storage devices with at least enough combined storage capacity to contain computer-readable program instructions 1926 and any associated/related data structures.

Computer-readable program instructions 1926 and any data structures contained in data storage 1926 include computer-readable program instructions executable by processor(s) 1923 and any storage required, respectively, to perform at least part of herein-described methods, including, but not limited to: method 100 described with respect to FIG. 1, method 200 described with respect to FIG. 2, and/or method 2000 described with respect to FIG. 20.

### Example Methods of Operation

FIG. 20 is a flow chart of an example method 2000. Method 2000 can be carried out by computing device, such as computing device 1920 discussed above in the context of FIG. 19B.

Method 2000 can begin at block 2010, where a computing device can determine one or more representations of sequence features of a reference genome, as discussed above in the context of at least FIG. 2.

In some embodiments, determining one or more representations of sequence features can include: receiving an input specifying genomic coordinates of the reference genome; querying a database for a sequence corresponding to the specified genomic coordinates of the reference genome; and in response to querying the database, receiving a query response comprising a representation of the genomic sequence that corresponds to the specified genomic coordinates, as discussed above in the context of at least FIG. 2.

In other embodiments, a designated sequence feature of the sequence features can include a portion unsuitable for mapping. Then, determining the one or more representations of sequence features can include: identifying the portion unsuitable for mapping in the designated sequence feature, and discarding the portion unsuitable for mapping from the representation of the designated sequence feature.

At block 2020, the computing device can assess a set of possible target arms that meet one or more design criteria for a MIP in matching the one or more representations of sequence features, as discussed above in the context of at least FIG. 2.

In some embodiments, the one or more design criteria can include a range of target arm sizes from a minimum size TAmin to a maximum size TAmax with TAmin≦TAmax, and where TAmin and TAmax are each specified as a number of base pairs, as discussed above in the context of at least FIG. 2. In particular embodiments, the genomic-sequence representation can represent a number N of base pairs, where N>TAmax. Then, determining the set of designed MIPs includes determining two or more designed MIPs to tile the genomic-sequence representation representing N base pairs.

At block 2030, the computing device can, for each possible pair of target arms in the set of possible target arms that meet the one or more design criteria: determine MIP performance data features for the possible pair of target arms, and determine a score for the possible pair of target arms using a MIP performance model operating on the MIP performance data features for the possible pair of target arms, as discussed above in the context of at least FIG. 2.

At block 2040, the computing device can determine a subset of the set of possible target arms that tile each of the one or more representations of sequence features, where the subset can be determined based on the scores for the set of possible target arms, as discussed above in the context of at least FIG. 2.

At block 2050, the computing device can determine a set of designed MIPs based on the subset of the set of possible target arms that collectively tile the entire one or more representations of sequence features using the computing device, as discussed above in the context of at least FIG. 2.

In some embodiments, each designed MIP includes at least one pair of possible target arms in the subset of the set of possible target arms that tile each of the one or more representations of sequence feature, as discussed above in the context of at least FIG. 2.

At block 2060, the computing device can provide an output including information about each designed MIP of the set of designed MIPs, as discussed above in the context of at least FIG. 2.

In some embodiments, method 2000 can further include: determining a training-genomic-sequence representation configured to represent one or more base pairs of a genomic sequence; determining a plurality of training probes based on the training-genomic-sequence representation; determining a read score for each of plurality of training probes, where the read score for each training probe indicates performance of the training probe in matching a portion of the training-genomic-sequence representation; and determining the MIP performance model based on the plurality of read scores, as discussed above in the context of at least FIG. 1.

In particular of these embodiments, determining the MIP performance model can include: screening each training probe of the plurality of training probes by at least: determining whether a read score for the training probe exceeds a predetermined minimum read score, and after determining that the read score does not exceed the predetermined minimum read score, discarding the training probe from the plurality of training probes; and determining the MIP performance model based on the screened plurality of training probes, as discussed above in the context of at least FIG. 1.

In more particular of these embodiments, screening each training probe of the plurality of training probes can include: determining whether the read score for the training probe exceeds a predetermined maximum read score; and after determining that the read score does exceed the predetermined maximum read score, discarding the training probe from the plurality of training probes, as discussed above in the context of at least FIG. 1.

In other embodiments, the MIP performance model can be at least one of a logistic regression model and a support-vector-regression (SVR) model, as discussed above in the context of at least FIGS. 1 and 2.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The above description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

Numerous modifications and variations of the present disclosure are possible in light of the above teachings.

1. A method, comprising:
determining, at a computing device, one or more representations of sequence features of a reference genome;
assessing a set of possible target arms that meet one or more design criteria for a molecular interface probe (MIP) in matching the one or more representations of sequence features using the computing device;
for each possible pair of target arms in the set of possible target arms that meet the one or more design criteria, the computing device:
determining MIP performance data features for the pair of possible target arms, and
determining a score for the pair of possible target arms using a MIP performance model operating on the MIP performance data features for the pair of possible target arms;
determining a subset of the set of possible target arms that tile each of the one or more representations of sequence features using the computing device, wherein the subset is determined based on the scores for the set of possible target arms;
determining a set of designed MIPs based on the subset of the set of possible target arms that collectively tile all of the one or more representations of sequence features using the computing device; and
providing an output comprising information about each designed MIP of the set of designed MIPs using the computing device.

2. The method of claim 1, wherein determining the one or more representations of sequence features comprises:
receiving an input specifying genomic coordinates of the reference genome;
querying a database for a sequence corresponding to the specified genomic coordinates of the reference genome; and
in response to querying the database, receiving a query response comprising a representation of the genomic sequence that corresponds to the specified genomic coordinates.

3. The method of claim 1, wherein each designed MIP comprises at least one pair of possible target arms in the subset of the set of possible target arms that tile each of the one or more representations of sequence features.

4. The method of claim 1, wherein the one or more design criteria comprise a range of target arm sizes from a minimum size TAmin to a maximum size TAmax with TAmin≦TAmax, and where TAmin and TAmax are each specified as a number of base pairs.

5. The method of claim 4, wherein the genomic-sequence representation represents a number N of base pairs, wherein N>TAmax, and wherein determining the set of designed MIPs comprises determining two or more designed MIPs to tile the genomic-sequence representation representing N base pairs.

6. The method of claim 1, wherein the one or more design criteria comprise an SNP avoidance flag and/or a low complexity area avoidance flag.

7. The method of claim 1, wherein a designated sequence feature of the sequence features comprises a portion unsuitable for mapping, and wherein determining the one or more representations of sequence features comprises:
identifying the portion unsuitable for mapping in the designated sequence feature; and
discarding the portion unsuitable for mapping from the representation of the designated sequence feature.

8. The method of claim 1, further comprising:
determining a training-genomic-sequence representation configured to represent one or more base pairs of a genomic sequence;
determining a plurality of training probes based on the training-genomic-sequence representation;
determining a read score for each of plurality of training probes, wherein the read score for each training probe indicates performance of the training probe in matching a portion of the training-genomic-sequence representation; and
determining the MIP performance model based on the plurality of read scores.

9. The method of claim 8, wherein determining the MIP performance model comprises:
screening each training probe of the plurality of training probes by at least:
determining whether a read score for the training probe exceeds a predetermined minimum read score, and
after determining that the read score does not exceed the predetermined minimum read score, discarding the training probe from the plurality of training probes; and
determining the MIP performance model based on the screened plurality of training probes.

10. The method of claim 9, wherein screening each training probe of the plurality of training probes further comprises:
determining whether the read score for the training probe exceeds a predetermined maximum read score; and
after determining that the read score does exceed the predetermined maximum read score, discarding the training probe from the plurality of training probes.

11. The method of claim 1, wherein the MIP performance model comprises at least one of a logistic regression model and a support-vector-regression (SVR) model.

12. A computing device, comprising:
a processor; and
a non-transitory tangible computer readable medium configured to store at least executable instructions, wherein the executable instructions, when executed by the processor, cause the computing device to perform functions comprising:
determining one or more representations of sequence features of a reference genome,
assessing a set of possible target arms that meet one or more design criteria for a molecular interface probe (MIP) in matching the one or more representations of sequence features,
for each possible pair of target arms in the set of possible target arms that meet the one or more design criteria:
determining MIP performance data features for the pair of possible target arms, and
determining a score for the pair of possible target arms using a MIP performance model operating on the MIP performance data features for the pair of possible target arms,
determining a subset of the set of possible target arms that tile each of the one or more representations of sequence features, wherein the subset is determined based on the scores for the set of possible target arms,
determining a set of designed MIPs based on the subset of the set of possible target arms that collectively tile all of the one or more representations of sequence features, and
providing an output comprising information about each designed MIP of the set of designed MIPs.

13. The computing device of claim 12, wherein determining the one or more representations of sequence features comprises:
receiving an input specifying genomic coordinates of the reference genome;
querying a database for a sequence corresponding to the specified genomic coordinates of the reference genome; and
in response to querying the database, receiving a query response comprising a representation of the genomic sequence that corresponds to the specified genomic coordinates.

14. The computing device of claim 12, wherein each designed MIP comprises at least one pair of possible target arms in the subset of the set of possible target arms that tile each of the one or more representations of sequence features.

15. The computing device of claim 12, wherein the one or more design criteria comprise a range of target arm sizes from a minimum size TAmin to a maximum size TAmax with TAmin≦TAmax, and where TAmin and TAmax are each specified as a number of base pairs.

16. The computing device of claim 15, wherein the genomic-sequence representation represents a number N of base pairs, wherein N>TAmax, and wherein determining the set of designed MIPs comprises determining two or more designed MIPs to tile the genomic-sequence representation representing N base pairs.

17. The computing device of claim 12, wherein a designated sequence feature of the sequence features comprises a portion unsuitable for mapping, and wherein determining the one or more representations of sequence features comprises:
identifying the portion unsuitable for mapping in the designated sequence feature; and
discarding the portion unsuitable for mapping from the representation of the designated sequence feature.

18. The computing device of claim 12, wherein the functions further comprise
determining a training-genomic-sequence representation configured to represent one or more base pairs of a genomic sequence;
determining a plurality of training probes based on the training-genomic-sequence representation;
determining a read score for each of plurality of training probes, wherein the read score for each training probe indicates performance of the training probe in matching a portion of the training-genomic-sequence representation; and
determining the MIP performance model based on the plurality of read scores.

19. The computing device of claim 12, wherein the MIP performance model comprises at least one of a logistic regression model and a support-vector-regression (SVR) model.

20. An article of manufacture comprising a non-transitory tangible computer readable medium configured to store at least executable instructions, wherein the executable instructions, when executed by a processor of a computing device, cause the computing device to perform functions comprising:
determining one or more representations of sequence features of a reference genome;
assessing a set of possible target arms that meet one or more design criteria for a molecular interface probe (MIP) in matching the one or more representations of sequence features;
for each possible pair of target arms in the set of possible target arms that meet the one or more design criteria:
determining MIP performance data features for the pair of possible target arms, and
determining a score for the pair of possible target arms using a MIP performance model operating on the MIP performance data features for the pair of possible target arms;
determining a subset of the set of possible target arms that tile all of the one or more representations of sequence features, wherein the subset is determined based on the scores for the set of possible target arms;
determining a set of designed MIPs based on the subset of the set of possible target arms that collectively tile each of the one or more representations of sequence features; and
providing an output comprising information about each designed MIP of the set of designed MIPs.
